(19) United States
(12) Patent Application Publication
(10) Pub. No.: US 2011/0001856 A1
(43) Pub. Date: Jan. 6, 2011

(54) IMAGE SENSOR

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/827,508

(22) Filed: Jun. 30, 2010

(30) Foreign Application Priority Data
Jul. 1, 2009 (JP) 2009-157234
Jun. 24, 2010 (JP) 2010-144073

(51) Int. Cl. H04N 5/225

(52) U.S. Cl. 348/294; 348/E05.024

(57) ABSTRACT

An image sensor comprising a plurality of first pixels is provided. The pixels comprise photoelectric converters and first optical members. The first optical member covers the photoelectric converter. Light incident on the photoelectric converter passes through the first optical member. The first pixels are arranged on a light-receiving area. First differences are created for the thicknesses of the first optical members in two of the first pixels in a part of first pixel pairs among all first pixel pairs. The first pixel pair includes two of the first pixels selected from the plurality of said first pixels.

### BACKGROUND OF THE INVENTION

1. Field of the Invention

The present invention relates to an image sensor that can reduce the influence of a ghost image within an entire captured image.

2. Description of the Related Art

Noise referred to as a ghost image is known. A ghost image is generated when an image sensor captures an optical image that passes directly through an imaging optical system as well as a part of the optical image that is reflected between lenses of the optical system before finally reaching the image sensor. It is known that a ghost noise is generated by reflected light incident on an image sensor.

Japanese Unexamined Patent Publication No. 2006-332433 discloses a micro-lens array that has many micro lens facing each pixel, and where the micro lenses have fine dimpled surfaces. By forming such micro lenses, the reflection at the surfaces of the micro lenses is decreased and the influence of a ghost image is reduced. In addition, Japanese Unexamined Patent Publication No. H01-298771 discloses the prevention of light from reflecting at the surface of a photoelectric converter by coating the photoelectric converter of an image sensor with a film.

The ghost image generated by the reflection of light between the lenses of the imaging optical system has a shape similar to a diaphragm, such as a circular or polygonal shape. The ghost image having such a shape is sometimes used as a photographic special effect even though it is noise.

A solid-state image sensor that was recently used in an imaging apparatus conducts a photoelectric conversion operation upon receiving an optical image prior to generating an image signal. Ideally, an optical image that reaches the light-receiving area of an image sensor is completely converted into an electrical image signal. However, a part of the optical image is reflected at the light-receiving area. The reflected optical image is reflected by the lens of the imaging optical system to the image sensor. The image sensor captures both the direct optical image as well as the reflected optical image. A ghost image may be generated by the reflected optical image.

A plurality of photoelectric converters arranged regularly on the light-receiving area of an image sensor works as a diffraction grating for incident light. Accordingly, light reflected at an image sensor forms a repeating image pattern that alternates between brightness and darkness. The light reflected at an image sensor is reflected once more by a lens before being made incident on the image sensor again. Accordingly, the ghost image generated by the reflection of light at the photoelectric converters has a polka-dot pattern.

Because such a ghost image is generated by light reflected at the photoelectric converters, the micro lens having a finely dimpled surface, which is disclosed by Japanese Unexamined Patent Publication No. 2006-332433, cannot prevent the ghost image from appearing. In addition, such a polka-dot ghost image is more unnatural and noticeable than a ghost image generated by light reflected between the lenses. Accordingly, even if the light reflected by the photoelectric converters is reduced according to the above Japanese Unexamined Patent Publication No. H01-298771, an entire image still includes an unnatural and noticeable pattern.

### SUMMARY OF THE INVENTION

Therefore, an object of the present invention is to provide an image sensor that can effectively reduce the influence of a ghost image generated by the reflection of an optical image between the image sensor and the lens.

According to the present invention, an image sensor comprising a plurality of first pixels is provided. The pixels comprise photoelectric converters and first optical members. The first optical member covers the photoelectric converter. Light incident on the photoelectric converter passes through the first optical member. The first pixels are arranged on a light-receiving area. First differences are created for the thicknesses of the first optical members in two of the first pixels in a part of first pixel pairs among all first pixel pairs. The first pixel pair includes two of the first pixels selected from the plurality of said first pixels.

According to the present invention, an image sensor comprising a plurality of first pixels is provided. The first pixels comprise photoelectric converters and are arranged on a light-receiving area. First optical members are mounted only on the first pixels positioned in a predetermined cycle among the plurality of first pixels.

According to the present invention, an image sensor comprising a plurality of first pixels and a plurality of second pixels is provided. The first pixels comprise photoelectric converters, first optical filters, and first micro lenses. The first optical filter covers the photoelectric converter. A portion of the total light incident on the first pixel has a first wavelength band and passes through the first optical filter. The first micro lens covers the photoelectric converter. Light incident on the photoelectric converter passes through the first micro lens. The first pixels are arranged on a light-receiving area. The second pixels comprise photoelectric converters, second optical filters, and second micro lenses. The second optical filter covers the photoelectric converter. A portion of the total light incident on the second pixel has a second wavelength band and passes through the second optical filter. The second micro lens covers the photoelectric converter. Light incident on the photoelectric converter passes through the second micro lens. The second wavelength band is different from the first wavelength band. The second pixels are arranged on a light-receiving area. First differences are created for the thickness of the first micro lenses in two of the first pixels in a part of first pixel pairs among all of the first pixel pairs. The first pixel pair includes two of the first pixels selected from the plurality of the first pixels. Second differences are created for the thickness of the second micro lenses in two of the second pixels in part of second pixel pairs among all of the second pixel pairs. The second pixel pair includes two of the second pixels selected from the plurality of said second pixels.

### BRIEF DESCRIPTION OF THE DRAWINGS

The objects and advantages of the present invention will be better understood from the following description, with reference to the accompanying drawings in which:

FIG. 1 shows a mechanism for generating the ghost image based on light reflected between the lenses;

FIG. 2 shows a mechanism for generating the ghost image based on light reflected between the image sensor and the lens;

FIG. 3 is a sectional view of the image sensor of the first embodiment;

FIG. 4 is a sectional view of the image sensor of the first embodiment including dimensions of the inside reflected optical path length;

FIG. 5 is a sectional view of the image sensor of the first embodiment showing variations of the diffraction angle;

FIG. 6 is a polka-dot pattern of the ghost image generated by various image sensors;

FIG. 7 is a plane view of a part of the image sensor;

FIG. 8 is a polka-dot pattern of the r-d-ghost image for different colored light;

FIG. 9 shows the relationship between the different diffraction angles and the contrast of the diffraction light;

FIG. 10 shows the relationship between the arrangement of the lengthened pixels and the normal pixels, and the in-r-difference between pairs of pixels;

FIG. 11 is a deployment arrangement of the Bayer color array;

FIG. 12 shows positions of neighboring pixels, first and second next-neighboring pixels against a target pixel;

FIG. 13 is a pixel deployment diagram showing the arrangement of pixels on the image sensor of the first embodiment;

FIG. 14 is an in-r-difference indication diagram showing the existence of the in-r-difference between pixels and neighboring pixels in the first embodiment;

FIG. 15 is an in-r-difference indication diagram showing the existence of the in-r-difference between pixels and first next-neighboring pixels in the first embodiment;

FIG. 16 is an in-r-difference indication diagram showing the existence of the in-r-difference between pixels and second next-neighboring pixels in the first embodiment;

FIG. 17 is a pixel deployment diagram showing the arrangement of pixels on the image sensor of the second embodiment;

FIG. 18 is an in-r-difference indication diagram showing the existence of the in-r-difference between pixels and neighboring pixels in the second embodiment;

FIG. 19 is an in-r-difference indication diagram showing the existence of the in-r-difference between pixels and first next-neighboring pixels in the second embodiment;

FIG. 20 is an in-r-difference indication diagram showing the existence of the in-r-difference between pixels and second next-neighboring pixels in the second embodiment;

FIG. 21 is a pixel deployment diagram showing the arrangement of pixels on the image sensor in the third embodiment;

FIG. 22 is an in-r-difference indication diagram showing the existence of the in-r-difference between pixels and neighboring pixels in the third embodiment;

FIG. 23 is an in-r-difference indication diagram showing the existence of the in-r-difference between pixels and first next-neighboring pixels in the third embodiment;

FIG. 24 is an in-r-difference indication diagram showing the existence of the in-r-difference between pixels and second next-neighboring pixels in the third embodiment;

FIG. 25 is a pixel deployment diagram showing the arrangement of pixels on the image sensor in the fourth embodiment;

FIG. 26 is an in-r-difference indication diagram showing the existence of the in-r-difference between pixels and neighboring pixels in the fourth embodiment;

FIG. 27 is an in-r-difference indication diagram showing the existence of the in-r-difference between pixels and first next-neighboring pixels in the fourth embodiment;

FIG. 28 is an in-r-difference indication diagram showing the existence of the in-r-difference between pixels and second next-neighboring pixels in the fourth embodiment;

FIG. 29 is a pixel deployment diagram showing the arrangement of the lengthened pixels and the normal pixels each having red, yellow, green, and blue color filters on the image sensor in the fifth embodiment;

FIG. 30 is a pixel deployment diagram showing the arrangement of pixels on the image sensor in the seventh to tenth embodiments;

FIG. 31 is a sectional view of the image sensor of the eleventh embodiment;

FIG. 32 is a sectional view of the image sensor of the twelfth embodiment;

FIG. 33 is a sectional view of the image sensor of the thirteenth embodiment;

FIG. 34 is a deployment diagram of r-, g-, and b-pixels according to a special color filter array;

FIG. 35 shows the contrast of the diffraction light of the first example;

FIG. 36 shows the contrast of the diffraction light of the second example;

FIG. 37 shows the contrast of the diffraction light of the third example;

FIG. 38 shows the contrast of the diffraction light of the fourth example; and

FIG. 39 shows the contrast of the diffraction light of the first comparative example.

### DESCRIPTION OF THE PREFERRED EMBODIMENTS

The present invention is described below with references to the embodiments shown in the drawings.

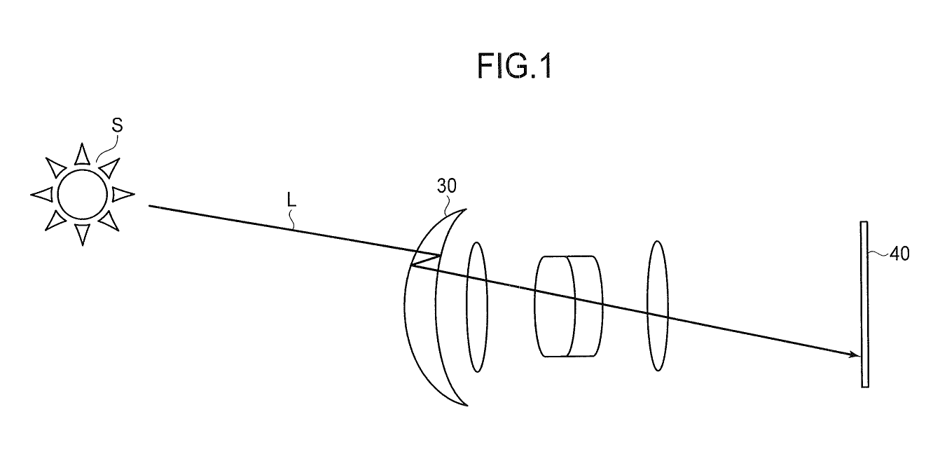

It is known that sunlight incident on an optical system of an imaging apparatus (not depicted) causes a ghost image to be captured in a photographed image. For example, as shown in FIG. 1, a ghost image is generated when incident light (see “L”) reflected inside a lens of an imaging optical system 30 is made incident on an image sensor 40. The ghost image has a single circular shape or a polygonal shape.

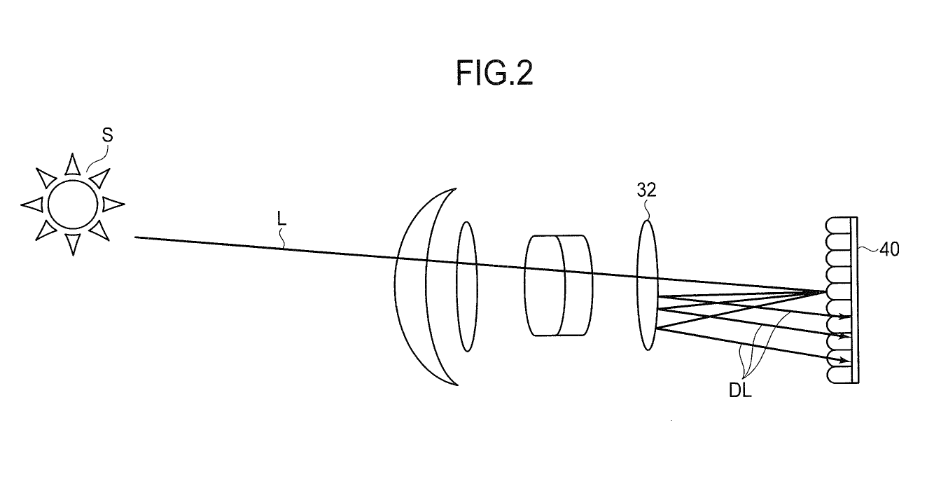

On the other hand, as shown in FIG. 2, when incident light is reflected by an image sensor 40 a plurality of beams of diffraction light (see “DL”) travels in various directions. The plurality of beams of light is reflected again by a lens 32 of the imaging optical system 30 and made incident on the image sensor 40. Accordingly, the ghost image generated by the plurality of beams has a polka-dot pattern consisting of a plurality of bright dots.

Such a polka-dot pattern causes the image quality of a photoelectric converted image to deteriorate. In the embodiment, the shape or pattern of a ghost image changes when improvements specifically designed to improve the image quality are made to the structure of an image sensor, as described below.

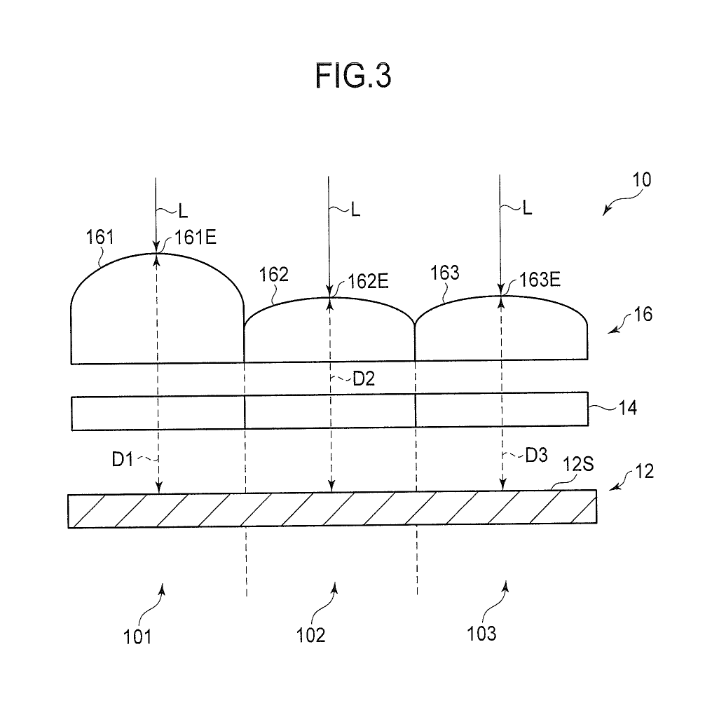

As shown in FIG. 3, an image sensor 10 of the first embodiment comprises a photoelectric conversion layer 12, a color filter 14, and micro-lens array 16. Light incident on the image sensor 10 strikes the micro-lens array 16, which is located at the outside surface of the image sensor 10. The light incident on the micro-lens array 16 passes through the micro-lens array 16 and the color filter layer before reaching the light-receiving area of the photoelectric conversion layer 12.

In the first embodiment, the image sensor 10 comprises a plurality of pixels. Each of the pixels comprises one photoelectric converter of which a plurality is arranged on the photoelectric conversion layer 12, one color filter of which a plurality is arranged on the color filter layer 14, and one micro lens of which a plurality is arranged on the micro-lens array 16.

A plurality of pixels having various distances between an external surface of the micro-lens array 16 and the photoelectric conversion layer 14 is arranged regularly in the image sensor 10.

For example, a first micro lens 161 of a first pixel 101 is formed so that the thickness of the first micro lens 161 is greater than the thickness of second and third micro lenses 162, 163 of second and third pixels 102, 103. In addition, the second and third micro lenses 162, 163 are formed so that their thicknesses are equal to each other.

Accordingly, distances (see “D2” and “D3” in FIG. 3) between the external surface 162E, 163E of the second and third micro lens 162, 163 and the photoelectric conversion layer 12 are shorter than that (see “D1”) between the external surface 161E of the first micro lens 161 and the photoelectric conversion layer 12. Accordingly, the vertical positions of the external surfaces of the micro lenses are different for different parts of pairs of pixels.

Owing to the differences in the vertical positions, an inside reflected optical path length (OPL) in the first pixel 101 is different from those in the second and third pixels 102, 103, as explained below.

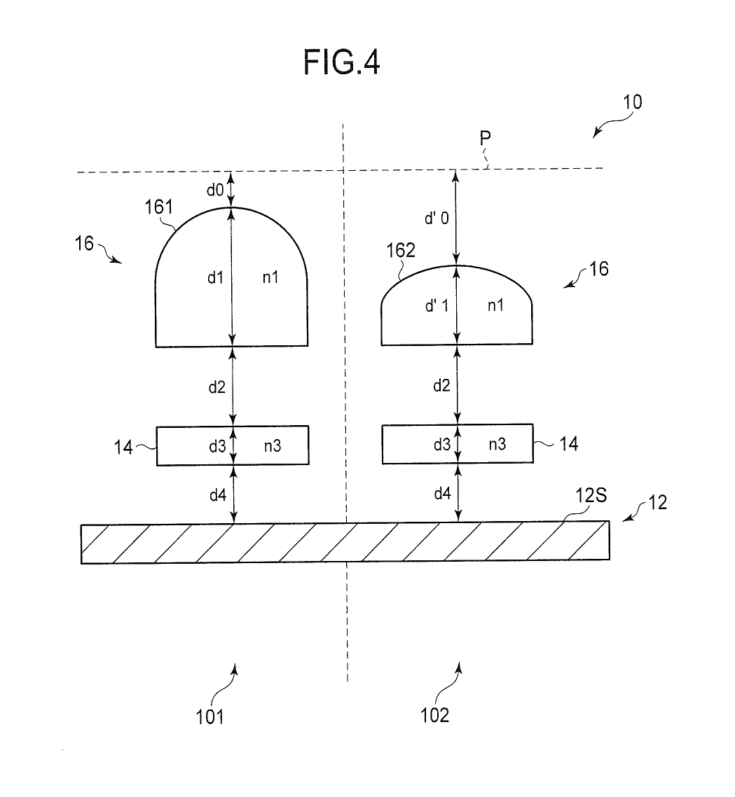

To explain the inside reflected OPL it is first necessary to designate a plane that is parallel to a light-receiving area of the photoelectric conversion layer 12 and further from the photoelectric conversion layer 12 than the micro-lens array 16 as an imagined plane (see “P” in FIG. 4).

Next the inside OPL can be calculated as the integral value of the thicknesses of the substances and spaces located between the photoelectric conversion layer 12 and the imagined plane multiplied by the respective refractive indexes of the substances and spaces. The inside reflected OPL is then calculated by multiplying the inside OPL by 2. In the first embodiment, the thickness of the substances and spaces used for the calculation of the inside OPL is their length along a straight line that passes through the top point of the micro lens and is perpendicular to the light-receiving area of the photoelectric conversion layer 12.

For example, as shown in FIG. 4, the inside reflected OPL of the first pixel 101 is ((d0×1)+(d1×n1)+(d2×1)+(d3×n3)+(d4×1))×2. The inside reflected OPL of the second pixel 102 is ((d′0×1)+(d′1×n1)+(d2×1)+(d3×n3)+(d4×1))×2. In the above and below calculation, the refractive index is determined to be 1.

The difference of the inside reflected OPL, hereinafter referred to as the in-r-difference, between the first and second pixels 101, 102 is calculated as ((d0×1)+(d1×n1)−(d′0×1)−(d′1×n1))×2. Using the equation of (d′0+d′1)=(d0+d1), the in-r-difference is calculated as ((d1−d′1)×(n1−1))×2.

In the first embodiment, by changing the thickness of the pixels' micro lenses 16 an in-r-difference is created between a pair of pixels according to the equation: (difference between thicknesses of the micro lenses)×((refractive index of the micro-lens array 16)−(refractive inde×of air)×2).

In the image sensor 10 having the in-r-difference, the direction of the diffraction light generated by the reflection of incident light at the photometric conversion layer 12 varies according to the configuration of pixel pairs.

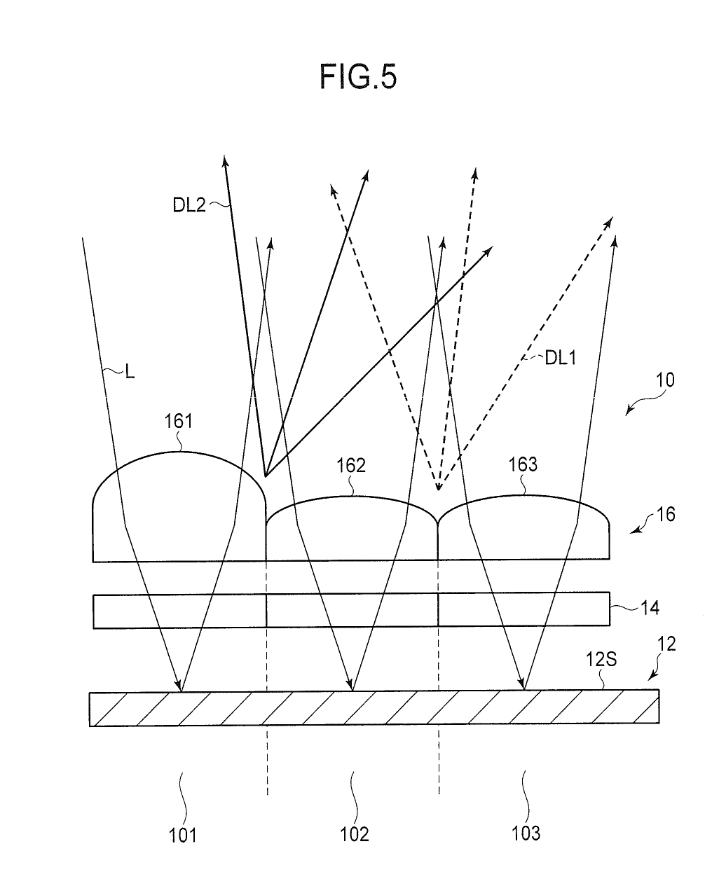

For example, as shown in FIG. 5A the in-r-difference between the second and third pixels 102, 103 is mλ (m being an integer and zero in this case, and λ being the wavelength of light incident on the photoelectric converter). Accordingly, the phases of light reflected by the photoelectric converters at the second and third pixels are equal. First diffraction light (see “DL1”) generated between the second and third pixels, of which the phases are equal, travel in the directions indicated by the dashed lines.

In another example, the micro-lens array 16 is configured so that the in-r-difference between the first and second pixels 101, 102 is (m+1/2)×λ, which creates a phase difference between the first and second pixels 101, 102. Second diffraction light (see “DL2”) generated between first and second pixels 101, 102 having different phases travels in the directions indicated by the solid lines.

The direction of the second diffraction light is in the center direction between the directions of neighboring first diffraction light. Hereinafter, the diffraction light, which travels in the center direction between two directions of integer-degree diffraction light, is called half-degree diffraction light. Similar to half-degree diffraction light, diffraction light that travels in the center direction between directions of half- and integer-degree diffraction light is called quarter-degree diffraction light.

The directions of diffraction light can be increased by changing the direction of the diffraction light resulting from producing the in-r-difference between two pixels. For example, by producing half-degree diffraction light the diffraction light that travels between zero- and one-degree diffraction light is generated.

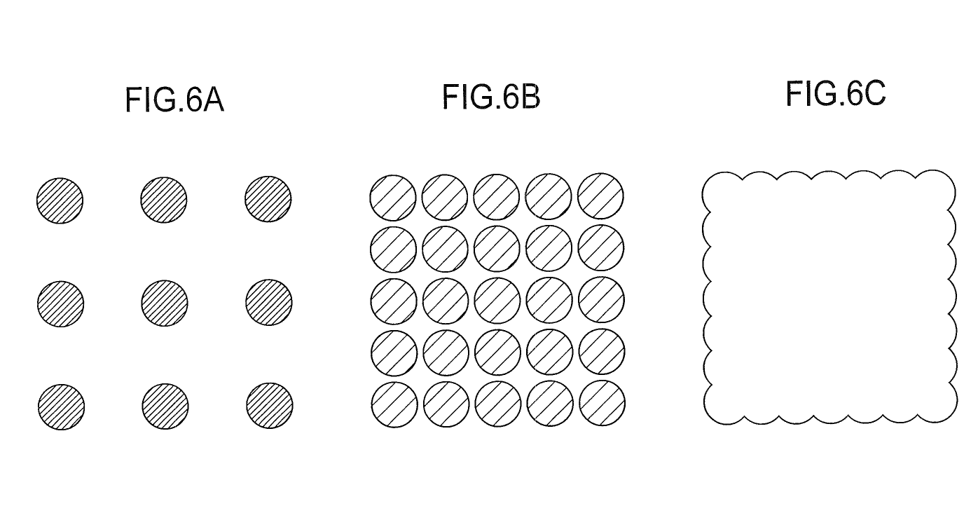

The contrast of a ghost image based on the diffraction light generated by reflection, hereinafter referred to as an r-d-ghost image, can be lowered by increasing the directions of the diffraction light. The mechanism for lowering the contrast of the r-d-ghost image is explained below using FIG. 6. FIG. 6 is a polka-dot pattern of the ghost image generated by various image sensors.

Using the image sensor 40 (see FIG. 2), which has no in-r-difference between pixels, the generated diffraction light based on the reflection at the photoelectric converter travels in the same directions between any pairs of pixels. Accordingly, as shown in FIG. 6A, the contrast of the ghost image based on the diffraction light using the image sensor 40 is relatively high. Consequently, the brightness of the dots in the polka-dot pattern of the ghost image is emphasized.

Using the image sensor of the first embodiment, the direction of partial diffraction light is changed and the diffraction light travels in various directions. Accordingly, as shown in FIGS. 6B and 6C, the contrast of the ghost image based on the diffraction light using the image sensor of the first embodiment is lowered.

Accordingly, even if the r-d-ghost image appears, each of the dots is unnoticeable because the number of dots within a certain area of the polka-dot pattern increases and the brightness of each dot decreases. Consequently, the image quality is prevented from deteriorating due to the r-d-ghost image. As described above, in the first embodiment, the impact of the r-d-ghost image on an image to be captured is reduced, and a substantial appearance of the r-d-ghost image is prevented.

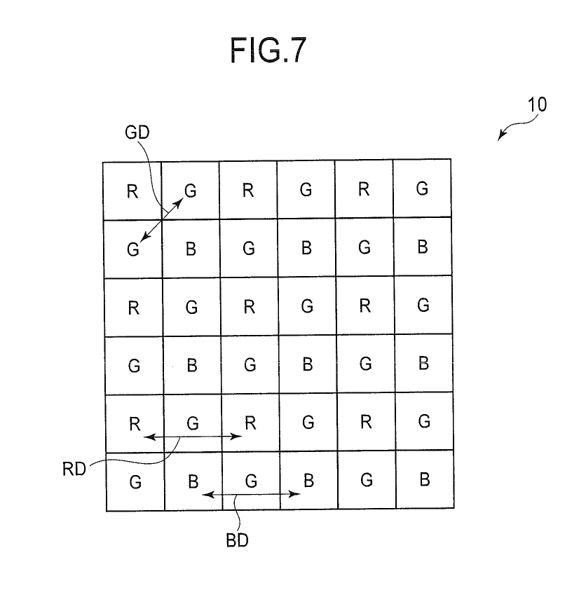

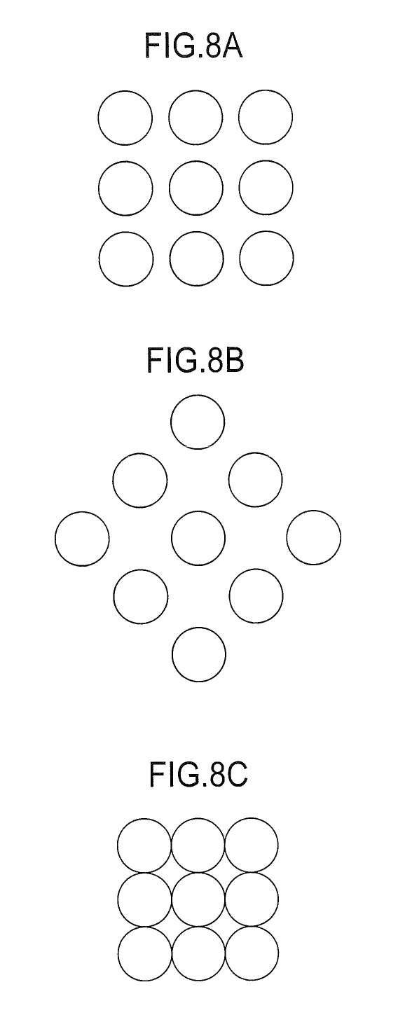

Next, the arrangement of color filters is explained below using FIG. 7. In addition, the breadth of the diffraction light for each of the colors is explained below using FIG. 8. FIG. 7 is a plane view of part of the image sensor 10. FIG. 8 is a polka-dot pattern of the r-d-ghost image for different colors of light.

In the image sensor 10, the pixels are two-dimensionally arranged in rows and columns. Each pixel comprises one of a red, green, and blue color filter. The color filter layer 14 comprises red, green, and blue color filters. The red, green, and blue color filters are arranged according to the Bayer color array. Hereinafter, pixels having the red, green, or blue color filters are referred to as an r-pixel, g-pixel, or b-pixel, respectively.

The light reflected at the photoelectric conversion layer 12 includes only colored light components in the band of wavelengths of a color filter because the reflected light passes through the color filter. Accordingly, the r-d-ghost image based on the reflection at the photoelectric conversion layer 12 is generated not between pairs of pixels having different color filters, but between pairs of pixels having the same color filters. For example, the diffraction light is generated between pairs of matching r-pixels, g-pixels or b-pixels.

Next, a diffraction angle for each color is explained below. The angle between the directions in which diffraction light of two successive integer degrees travels, such as a combination of zero and one-degree diffraction light and a combination of one- and two-degree diffraction light, is defined as the diffraction angle. The diffraction angle of the diffraction light (see “DL” in FIG. 5) is calculated from the equation: (wavelength of reflected light)/(distance between a pair of pixels).

The distance between a pair of r-pixels that are nearest to each other is 10 μm, for example. Then, the distance between a pair of b-pixels that are nearest to each other is also 10 μm. However, the distance between a pair of g-pixels that are nearest to each other is 7 μm.

A representative wavelength in the band of wavelengths of red light that passes through the red color filter is determined to be 630 nm. A representative wavelength in the band of wavelengths of green light that passes through the green color filter is determined to be 530 nm. A representative wavelength in the band of wavelengths of blue light that passes through the blue color filter is determined to be 420 nm.

Accordingly, the diffraction angle of the diffraction light generated based on the reflection at the photoelectric converter of the r-pixel is 630 nm/10 μm=63 rad (see FIG. 8A). The diffraction angle of the diffraction light generated based on the reflection at the photoelectric converter of the g-pixel is 530 nm/7 μm=76 rad (see FIG. 8B), which is the greatest among all colors. The diffraction angle of the diffraction light generated based on the reflection at the external surface 16A of the b-pixel is 420 nm/10 μm=60 rad (see FIG. 8C), which is the least among all colors. The diffraction angles of the diffraction light are different for r-pixels, g-pixels, and b-pixels.

As described above, the diffraction light generated based on the reflection at the photoelectric conversion layer 12 is generated between pairs of pixels having the same color filter. Accordingly, in the first embodiment, the micro-lens array 16 is formed so that there are various in-r-differences for each of the color filters. In other words, the in-r-differences are formed separately among r-pixels, g-pixels, and b-pixels. In the first embodiment, in order to maximize the effect for reducing the contrast, the in-r-differences are determined to be (m+1/2)×λ (m being an integer and λ being the respective representative wavelength of each color filter).

For example, assuming that the representative wavelengths are 630 nm, 530 nm, and 420 nm for r-, g-, and b-pixels, respectively, the in-r-differences for r-, g-, and b-pixels can be determined.

A wavelength corresponding to a peak within the band of wavelengths of light passing through each of the color filters and an average of the maximum and minimum wavelengths within the band of wavelengths of light passing through each of the color filters can both be also used as the representative wavelength, moreover, these values (peak and average) are approximately the same as those (630, 530, 420 nm) in the first embodiment. In the first embodiment, pixels having longer inside reflected OPLs and shorter inside reflected OPLs are arranged according to the band of wavelengths of light passing through each of the color filters.

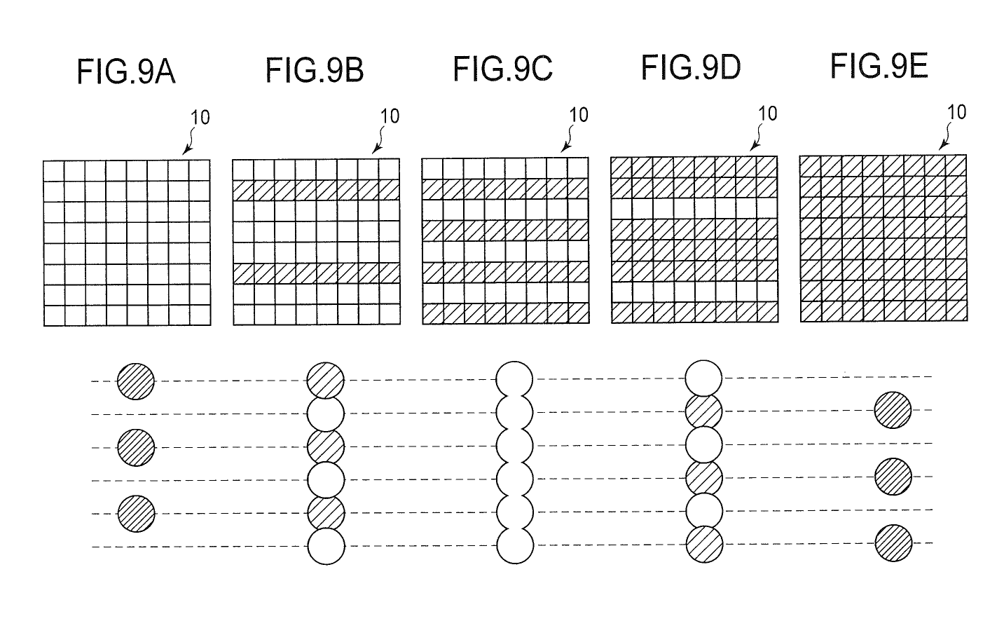

FIG. 9 conceptually shows the relation between the arrangement of pixels that have the in-r-difference with another pixel for one selected color pixel partially extracted from the Bayer color array, for example r-pixels, and the contrast of diffraction light generated between pairs of pixels having the same color filters.

As shown in FIG. 9A, when the inside reflected OPL is equal for all pixels of the image sensor 10, the contrast of the diffraction light is great. In such a case, the phases of the light reflected at the photoelectric converters of any pair of neighboring pixels are equal. Accordingly, the first diffraction light (see “DL1” in FIG. 5), which travels in the same direction (see dashed line), is generated between all pairs of neighboring pixels. The polka-dot pattern having high contrast is generated because the diffraction light forms bright dots by concentrating the diffraction light on the same area of the image sensor.

As shown in FIG. 9B, the contrast is reduced slightly by arranging pixels so that some pairs of neighboring pixels have the in-r-difference. Some pairs of neighboring pixels have the in-r-difference by making the inside reflected OPL longer for some pixels and shorter for other pixels. In FIGS. 9B to 9(E), the pixels having the longer inside reflected OPL, hereinafter referred to as lengthened pixels, are shaded, whereas the pixels having the shorter inside reflected OPL, hereinafter referred to as normal pixels, are white.

As shown in FIG. 9C, the contrast of the diffraction light is reduced substantially by arranging pixels so that half of all pixels are lengthened pixels. In such a case, the first diffraction light (see “DL1” in FIG. 5) that travels in the same direction (see dashed line) is generated between half of the pairs of neighboring pixels, and the second diffraction light (see “DL2”) that travels in a direction (see continuous line) different from that of the first diffraction light is generated between the other half of neighboring pixel pairs. In this case, roughly half of the diffraction light reaches an area that the other half does not reach. Accordingly, the contrast of the diffraction light is minimized.

When more than half of pixels are the lengthened pixels (see FIG. 9D), the contrast is greater than the contrast derived from an image sensor having an equal number of lengthened pixels and normal pixels. When all of the pixels are lengthened pixels (see FIG. 9(E)), the contrast is even greater.

When all of the pixels are lengthened pixels, the inside reflected OPL is equal for all pixels. For example using FIG. 5, the second diffraction light (see “DL2” in FIG. 5) that travels in the same direction (see continuous line) is generated between all neighboring pixel pairs. In other words, the first diffraction light is not generated. Accordingly, though the direction of the diffraction light changes from the case shown in FIG. 9A, the contrast of the diffraction light is mostly the same as that in the case shown in FIG. 9A.

Accordingly, it is necessary to vary the direction of the diffraction light by arranging pixels so that some of the pairs of pixels have an in-r-difference. In addition, it is particularly desirable for half of all pixel pairs to have an in-r-difference.

For example, a diffraction angle of one-half is obtained by equally mixing the integer-degree diffraction light with the half-degree diffraction light. Next, the arrangement of the lengthened pixels and the in-r-difference are explained below.

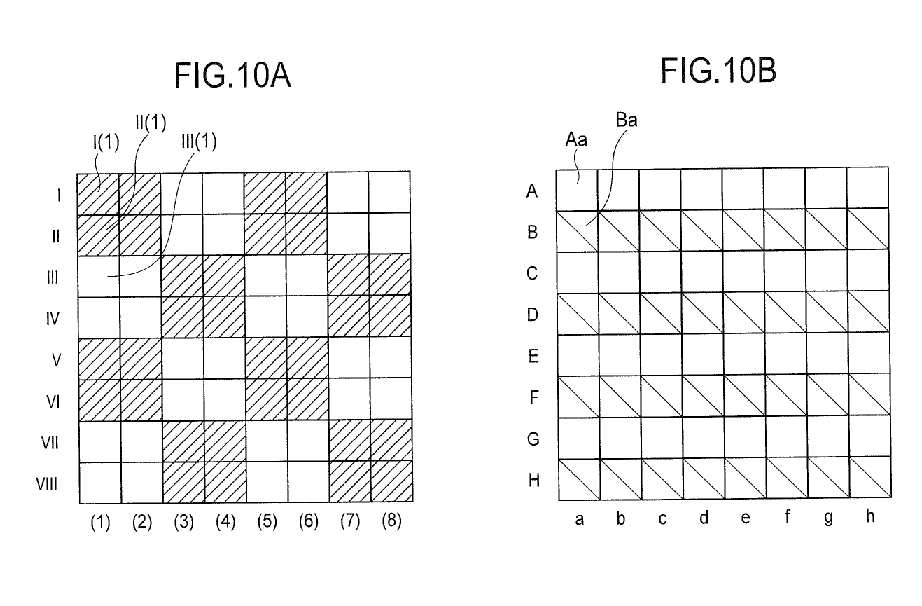

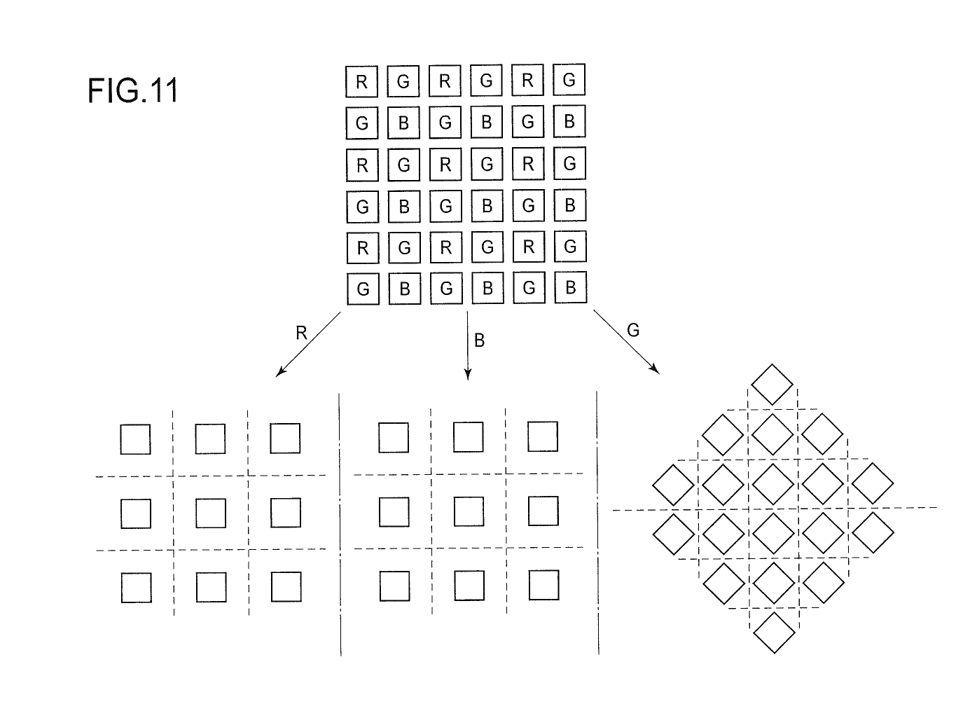

The arrangement of pixels of the first embodiment and the effect are explained using a pixel deployment diagram and an in-r-difference diagram. The example of the pixel deployment diagram and the in-r-difference diagram is illustrated in FIG. 10. In addition, the definitions of a neighboring pixel and a next-neighboring pixel for a target pixel are explained below using FIG. 11.

FIG. 10 shows the relation between the arrangement of the lengthened pixels and the normal pixels, and the in-r-difference between pixel pairs. As described above, it is necessary to arrange the lengthened pixels and the normal pixels separately for each of the color filters. The pixel deployment diagrams shown in FIG. 10 and later figures are deployment diagrams for the r-pixels. However, the arrangements of the lengthened pixels and the normal pixels for the g-pixels and b-pixels are the same as those of the r-pixels.

The r-pixels in a Bayer color array form a matrix having rows and columns, as shown in FIG. 11. The b-pixels in a Bayer color array also form a matrix having rows and columns, as shown in FIG. 11. Accordingly, the arrangement of the lengthened pixels for the b-pixels is the same as that for the r-pixels. In addition, the g-pixels rotated by 45 degrees in a Bayer color array also forms a matrix having rows and columns, as shown in FIG. 11. Accordingly, the arrangement of the lengthened pixels for the g-pixels rotated by 45 degrees is the same as that for the r-pixels.

The normal pixels (white panels in FIG. 10A) that have the shorter inside OPLs and the lengthened pixels (shaded panels in FIG. 10A) that have longer inside OPLs are located on the image sensor 10. The in-r-difference between the lengthened pixels and normal pixels is (m+1/2)×λ.

The inside reflected OPL is twice as great as the inside OPL, as described above. Accordingly, when the inside OPL is equal for some pixel pairs, the inside reflected OPL is also equal for those same pixel pairs. Ideally the in-r-difference between normal and lengthened pixels is (m+1/2)×λ. However, the phase difference can be shifted higher or lower. In other words, the in-r-difference may be shifted slightly from (m+1/2)×λ.

FIG. 10B shows the in-r-difference between target pixels, which are designated one-by-one among all of the pixels in FIG. 10A, and their respective neighboring pixels arranged one row below the target pixels. In FIG. 10B, the white panels indicate pixels that do not have an in-r-difference with respect to their neighboring pixel positioned one row below while the panels marked with diagonal lines represent pixels that have an in-r-difference with respect to their neighboring pixels arranged one row below.

For example, in FIG. 10A, the inside OPL of the pixel represented by the panel at the intersection of the top row and first (leftmost) column is equal to that of the pixel positioned in the second row of the first column. Accordingly, in FIG. 10B, the panel representing the pixel arranged in the first row and the first column is white.

In the first embodiment and other embodiments, a neighboring pixel of a target pixel is not limited to a pixel that is adjacent to the target pixel, but instead indicates a pixel nearest to the target pixel among the same color pixels, i.e. r-, g-, or b-pixels.

In addition, in FIG. 10A, an in-r-difference exists between the pixel arranged in the second row of the first column and the pixel arranged in the third row of the first column. Accordingly, in FIG. 10B, the pixel arranged in the second row of the first column is represented by a panel with a diagonal line.

The arrangement of the pixels and the effect derived from the arrangement in the first embodiment are explained below using a pixel deployment diagram, such as FIG. 10A, which shows the arrangement of the lengthened and normal pixels, and an in-r-difference diagram, such as FIG. 10B, which shows the in-r-difference for each pixel with respect to another pixel.

In FIG. 10B, the in-r-difference between a target pixel and a neighboring pixel arranged one row below is shown in order to indicate the diffraction light generated between pairs of neighboring pixels. However, diffraction light is not limited to light generated only from pairs of a target pixel and a neighboring pixel arranged one row below.

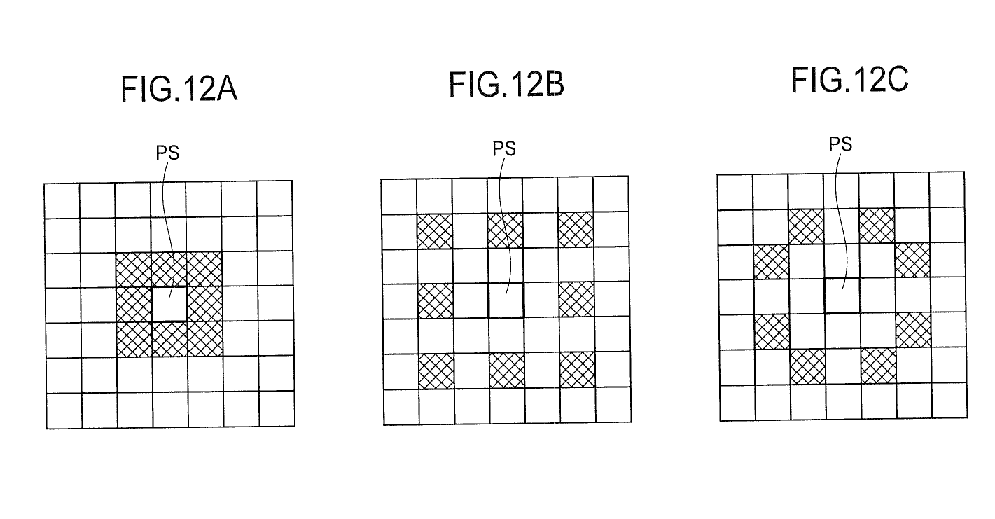

As shown in FIG. 12A, eight shaded panels represent eight neighboring pixels surrounding one target pixel represented by the white panel marked with “PS”. The diffraction light based on the reflection is generated between the target pixel and each of the eight neighboring pixels. As shown in FIGS. 12B and 12C, sixteen pixels surrounding the eight neighboring pixels are defined as next-neighboring pixels (see shaded panels). The diffraction light based on the reflection is also generated between the target pixel and each of the sixteen next-neighboring pixels.

The next-neighboring pixels are categorized into first and second next-neighboring pixels. The first next-neighboring pixels are the eight pixels arranged every 45 degrees and include the pixels on the same vertical and horizontal lines as the target pixel (see shaded panels in FIG. 12B). The second next-neighboring pixels are the eight other next-neighboring pixels positioned in between the first next-neighboring pixels (see shaded panels in FIG. 12C).

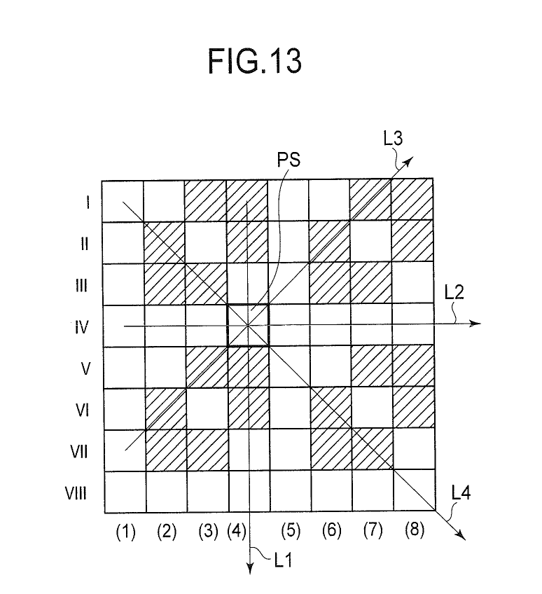

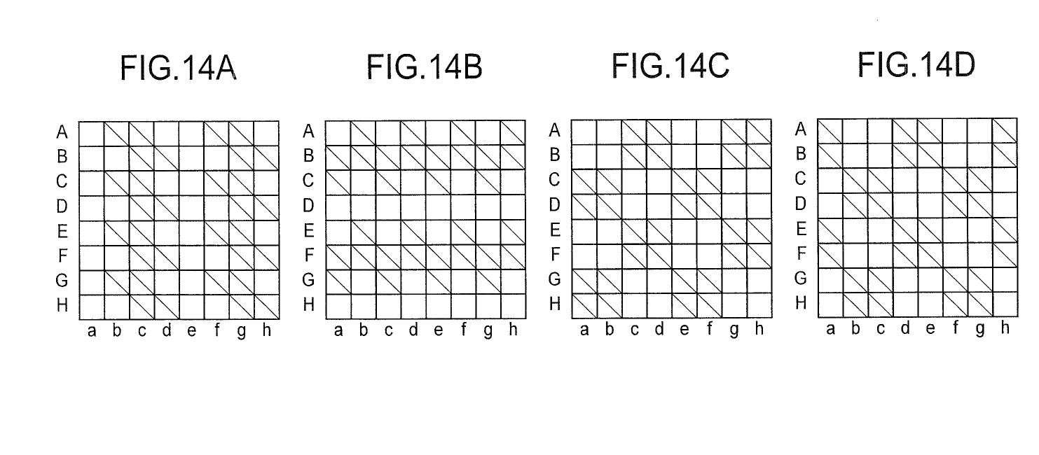

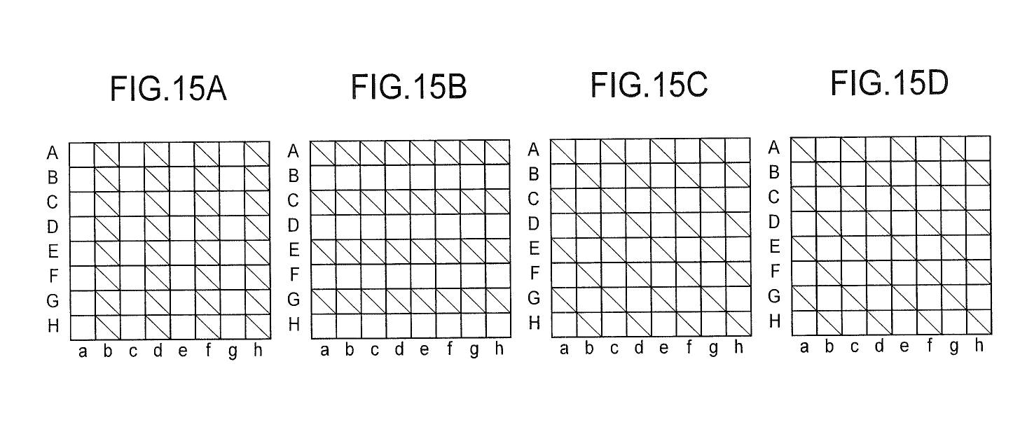

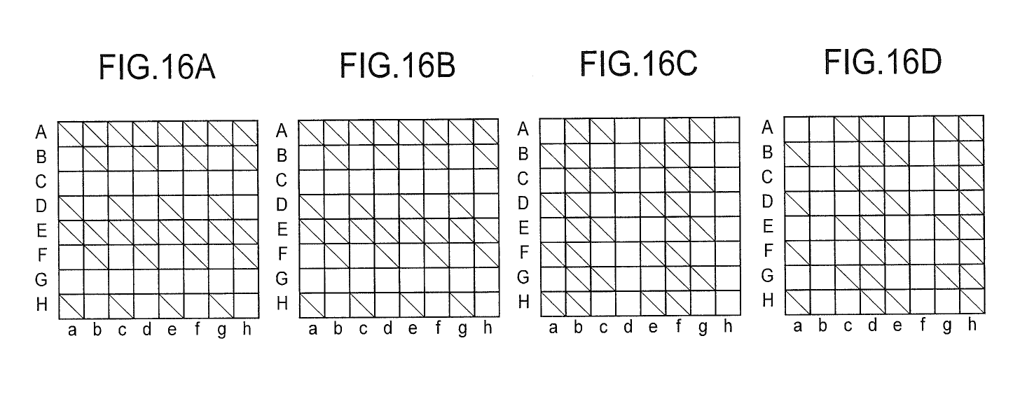

FIG. 13 is a pixel deployment diagram showing the arrangement of pixels on the image sensor 10 of the first embodiment. FIG. 14 is an in-r-difference diagram mapping the in-r-differences between each of the pixels and a neighboring pixel in the first embodiment. FIG. 15 is an in-r-difference diagram mapping the in-r-differences between each of the pixels and a first next-neighboring pixel in the first embodiment. FIG. 16 is an in-r-difference diagram mapping the in-r-differences between each of the pixels and a second next-neighboring pixel in the first embodiment.

As described above, in FIG. 13 and in the other pixel deployment diagrams, only r-pixels are shown from a plurality of r-, g-, and b-pixels arranged in a matrix. However, the arrangements for g- and b-pixels are the same as that of the r-pixels. As described above, the lengthened and normal pixels are arranged separately for r-, g-, and b-pixels because the diffraction angles are different for r-, g-, and b-pixels.

In FIG. 13 and in the other pixel deployment diagrams, first to fourth lines (see “L1 to L4”) are imaginary lines passing through the target pixel (see “PS”). The first line is a vertical line. The second line is a horizontal line. The third line is a diagonal line toward the upper-right direction from the target pixel. The fourth line is a diagonal line toward the lower-right direction from the target pixel. The first and second lines are perpendicular. The third and fourth lines are perpendicular. The arrangement shown in FIG. 13 is repeated over the entire light-receiving area of the image sensor 10.

FIG. 14A maps the in-r-differences between pairs comprising a target pixel and neighboring pixel positioned one row below.

Hereinafter, a pair of pixels that includes a target pixel and a neighboring or next-neighboring pixel relative to the target pixel is referred to as a pixel pair.

As shown in FIG. 14A, among pixel pairs including a target pixel and a neighboring pixel positioned one row below the target pixel, the number of pixel pairs having the in-r-difference is equal to the number of pixel pairs having the same inside reflected OPL. Although only pixel pairs including target pixels and neighboring pixels arranged one row below are considered in FIG. 14A, a similar result is obtained for pixel pairs including target pixels and neighboring pixels arranged one row above the target pixel.

FIG. 14B maps the in-r-differences between pixel pairs comprising a target pixel and a neighboring pixel arranged one column to the right of the target pixel. As shown in FIG. 14B, among pixel pairs containing a target pixel and a neighboring pixel positioned one column to the right, the number of pixel pairs having the in-r-difference is equal to the number of pixel pairs having the same inside reflected OPL.

FIG. 14C maps the in-r-differences between pixel pairs comprising a target pixel and a neighboring pixel arranged one row above and one column to the right of the target pixel. As shown in FIG. 14C, among pixel pairs including a target pixel and a neighboring pixel positioned one row above and one column to the right, the number of pixel pairs having the in-r-difference is equal to the number of pixel pairs having the same inside reflected OPL.

FIG. 14D maps the in-r-differences between pixel pairs comprising a target pixel and a neighboring pixel arranged one row below and one column to the right of the target pixel. As shown in FIG. 14D, among pixel pairs including a target pixel and a neighboring pixel positioned one row below and one column to the right, the number of pixel pairs having the in-r-difference is equal to the number of pixel pairs having the same inside reflected OPL.

FIG. 15A maps the in-r-differences between pixel pairs comprising a target pixel and a first next-neighboring pixel arranged two rows below the target pixel. As shown in FIG. 15A, among pixel pairs including a target pixel and a first next-neighboring pixel positioned two rows below, the number of pixel pairs having the in-r-difference is equal to the number of pixel pairs having the same inside reflected OPL.

FIG. 15B maps the in-r-differences between pixel pairs comprising a target pixel and a first next-neighboring pixel arranged two columns to the right of the target pixel. As shown in FIG. 15B, among pixel pairs including a target pixel and a first next-neighboring pixel positioned two columns to the right, the number of pixel pairs having the in-r-difference is equal to the number of pixel pairs having the same inside reflected OPL.

FIG. 15C maps the in-r-differences between pixel pairs comprising a target pixel and a first next-neighboring pixel arranged two rows above and two columns to the right of the target pixel. As shown in FIG. 15C, among pixel pairs including a target pixel and a first next-neighboring pixel positioned two rows above and two columns to the right, the number of pixel pairs having the in-r-difference is equal to the number of pixel pairs having the same inside reflected OPL.

FIG. 15D maps the in-r-differences between pixel pairs comprising a target pixel and a first next-neighboring pixel arranged two rows below and two columns to the right of the target pixel. As shown in FIG. 15D, among pixel pairs including a target pixel and a first next-neighboring pixel positioned two rows below and two columns to the right, the number of pixel pairs having the in-r-difference is equal to the number of pixel pairs having the same inside reflected OPL.

FIG. 16A maps the in-r-differences between pixel pairs comprising a target pixel and a second next-neighboring pixel arranged two rows below and one column to the right of the target pixel. As shown in FIG. 16A, among pixel pairs including a target pixel and a second next-neighboring pixel positioned two rows below and one column to the right, the number of pixel pairs having the in-r-difference is equal to the number of pixel pairs having the same inside reflected OPL.

FIG. 16B maps the in-r-differences between pixel pairs comprising a target pixel and a second next-neighboring pixel arranged two rows above and one column to the right of the target pixel. As shown in FIG. 16B, among pixel pairs including a target pixel and a second next-neighboring pixel positioned two rows above and one column to the right, the number of pixel pairs having the in-r-difference is equal to the number of pixel pairs having the same inside reflected OPL.

FIG. 16C, maps the in-r-differences between pixel pairs comprising a target pixel and a second next-neighboring pixel arranged one row below and two columns to the right of the target pixel. As shown in FIG. 16C, among pixel pairs including a target pixel and a second next-neighboring pixel positioned one row below and two columns to the right, the number of pixel pairs having the in-r-difference is equal to the number of pixel pairs having the same inside reflected OPL.

FIG. 16D maps the in-r-differences between pixel pairs comprising a target pixel and a second next-neighboring pixel arranged one row above and two columns to the right of the target pixel. As shown in FIG. 16C, among pixel pairs including a target pixel and a second next-neighboring pixel positioned one row above and two columns to the right, the number of pixel pairs having the in-r-difference is equal to the number of pixel pairs having the same inside reflected OPL.

In the above first embodiment, the number of pixel pairs including a target pixel and either a neighboring, first next-neighboring or second next-neighboring pixel for all directions and that have the in-r-differences of (m+1/2)×λ is equal to the number of pixel pairs having the same inside reflected OPL.

Also in the first embodiment, a pixel unit comprises 16 pixels, which are either lengthened or normal pixels, and are arranged in four rows by four columns in a specific arrangement pattern that depends on whether the pixels are r-, g-, or b-pixels (see FIG. 13). A plurality of pixel units is repeatedly and successively arranged vertically and horizontally on the image sensor 10.

The size of the pixel unit is determined on the basis of the diffraction limit of the wavelength of incident light. In other words, the size of the pixel unit is determined so that the size is approximately the same as the diameter of an airy disk. For example, for a commonly used imaging optical system, the length of one side of the pixel unit is determined to be roughly less than or equal to 20 μm-30 μm.

The contrast of the diffraction light can be effectively reduced by rearranging the lengthened and normal pixels in each pixel unit, which are nearly equal in size to a light spot formed by the concentration of incident light from a general optical system, so that the number of pixel pairs with and without the in-r-difference are in accordance with the scheme described above.

In the above first embodiment, the contrast of the diffraction light based on the reflection at members located inside of the color filter layer 14 can be reduced by rearranging the pixel pairs with the in-r-differences to create phase-differences between the reflected light from pairs of pixels that have the same color filter. By reducing the contrast of the diffraction light, the influence of the r-d-ghost image can be mitigated.

In addition, in the above first embodiment, the micro-lens array 16 having various thicknesses can be manufactured more easily than a micro lens with finely dimpled surfaces. Accordingly, the image sensor 10 can be manufactured more easily and the manufacturing cost can be reduced.

Next, an image sensor of the second embodiment is explained. The primary difference between the second embodiment and the first embodiment is the arrangement of normal pixels and lengthened pixels. The second embodiment is explained mainly with reference to the structures that differ from those of the first embodiment. To simplify matters, the same index numbers from the first embodiment will be used for corresponding structures in the second embodiment.

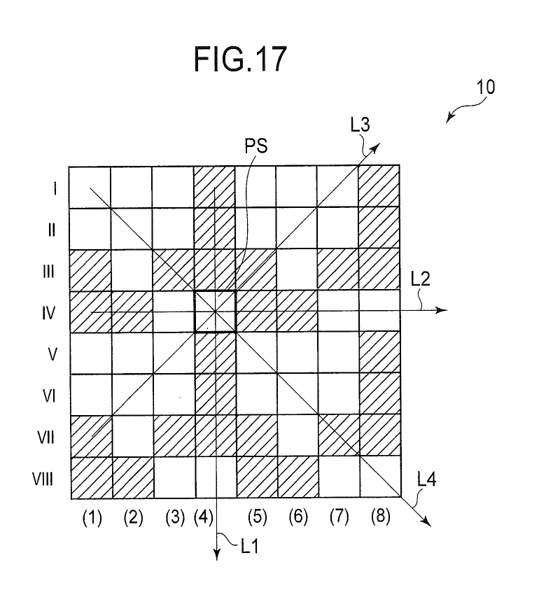

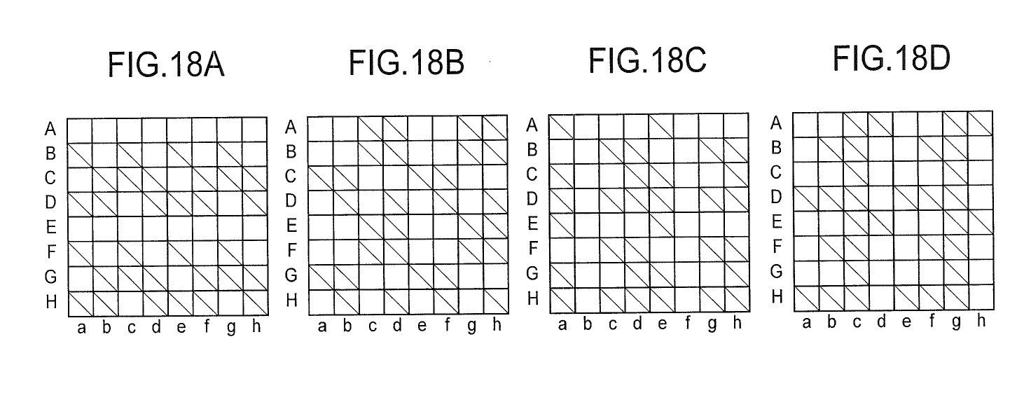

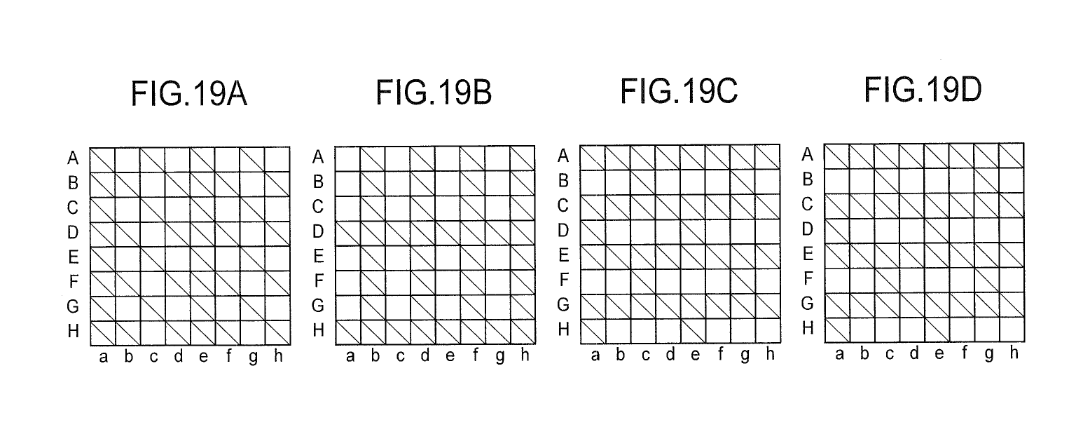

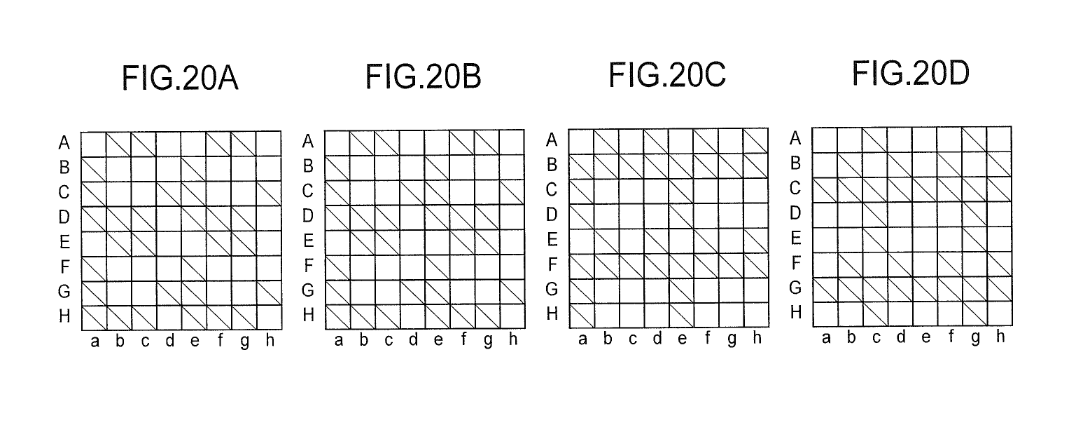

FIG. 17 is a pixel deployment diagram showing the arrangement of pixels on the image sensor 10 in the second embodiment. FIG. 18 is an in-r-difference diagram mapping the in-r-differences between each of the pixels and a neighboring pixel in the second embodiment. FIG. 19 is an in-r-difference diagram mapping the in-r-differences between each of the pixels and a first next-neighboring pixel in the second embodiment. FIG. 20 is an in-r-difference diagram mapping the in-r-differences between each of the pixels and a second next-neighboring pixel in the second embodiment.

FIG. 18A maps the in-r-differences between pixel pairs including a target pixel and a neighboring pixel arranged one row below the target pixel; FIG. 18B maps the in-r-differences between pixel pairs including a target pixel and a neighboring pixel arranged one column to the right of the target pixel; FIG. 18C maps the in-r-differences between pixel pairs including a target pixel and a neighboring pixel arranged one row above and one column to the right of the target pixel; and FIG. 18D maps the in-r-differences between pixel pairs including a target pixel and a neighboring pixel arranged one row below and one column to the right of the target pixel.

As shown in FIGS. 18A to 18D, among the pixel pairs comprising a target pixel and a neighboring pixel arranged in any direction from the target pixel, the number of pixel pairs having the in-r-difference is equal to the number of pixel pairs having the same inside reflected OPL.

FIG. 19A maps the in-r-differences between pixel pairs including a target pixel and a first next-neighboring pixel arranged two rows below the target pixel; FIG. 19B maps the in-r-differences between pixel pairs including a target pixel and a first next-neighboring pixel arranged two columns to the right of the target pixel; FIG. 19C maps the in-r-differences between pixel pairs including a target pixel and a first next-neighboring pixel arranged two rows above and two columns to the right of the target pixel; and FIG. 19D maps the in-r-differences between pixel pairs including a target pixel and a first next-neighboring pixel arranged two rows below and two columns to the right of the target pixel.

As shown in FIGS. 19A to 19D, among the pixel pairs comprising a target pixel and a first next-neighboring pixel arranged in any direction from the target pixel, the number of pixel pairs having the in-r-difference is greater than the number of pixel pairs having the same inside reflected OPL. The ratio of pixel pairs having the in-r-differences to all pixel pairs is about 63%.

FIG. 20A maps the in-r-differences between pixel pairs including a target pixel and second next-neighboring pixel in the same arrangement as FIG. 16A; FIG. 20B maps the in-r-differences between pixel pairs including a target pixel and a second next-neighboring pixel in the same arrangement as FIG. 165; FIG. 20C maps the in-r-differences between pixel pairs including a target pixel and a second next-neighboring pixel in the same arrangement as FIG. 16C; and FIG. 20D maps the in-r-differences between pixel pairs including a target pixel and a second next-neighboring pixel in the same arrangement as FIG. 16D.

As shown in FIGS. 20A to 20D, among the pixel pairs comprising a target pixel and a second next-neighboring pixel arranged in any direction from the target pixel, the number of pixel pairs having the in-r-difference is equal to the number of pixel pairs having the same inside reflected OPL.

In the above second embodiment, the number of pixel pairs having in-r-differences of (m+1/2)×λ and comprising a target pixel and either a neighboring pixel or a second next-neighboring pixel in any direction from the target pixel is equal to the number of pixel pairs having the same inside reflected OPL. However, the number of pixel pairs having in-r-differences and comprising a target pixel and a first next-neighboring pixel in any direction from the target pixel is greater than the number of pixel pairs having the same inside reflected OPL.

In the above second embodiment, the contrast of the diffraction light based on the reflection at members located inside of the color filter layer 14 can be reduced by rearranging the pixel pairs with the in-r-differences to create phase differences between the reflected light from pairs of pixels that have the same color filter. By reducing the contrast of the diffraction light, the influence of the r-d-ghost image can be mitigated.

The second embodiment is different from the first embodiment in that the number of pixel pairs having the in-r-difference among all of the pixel pairs comprising a target pixel and a first next-neighboring pixel is greater than the number of the pixel pairs having the same inside reflected OPL. Accordingly, the effect from reducing the influence of the r-d-ghost image in the second embodiment is less than that in the first embodiment. However, the influence of the r-d-ghost image can be sufficiently reduced in comparison to an image sensor having pixels with equal inside reflected OPLs.

Next, an image sensor of the third embodiment is explained. The primary difference between the third embodiment and the first embodiment is the arrangement of normal pixels and lengthened pixels. The third embodiment is explained mainly with reference to the structures that differ from those of the first embodiment. To simplify matters, the same index numbers from the first embodiment will be used for corresponding structures in the third embodiment.

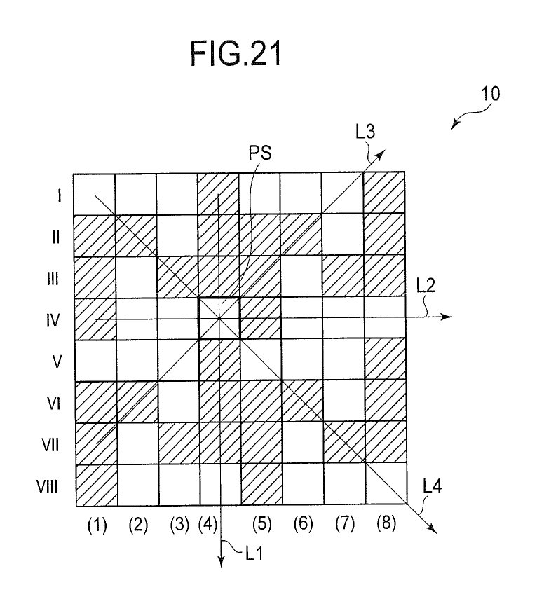

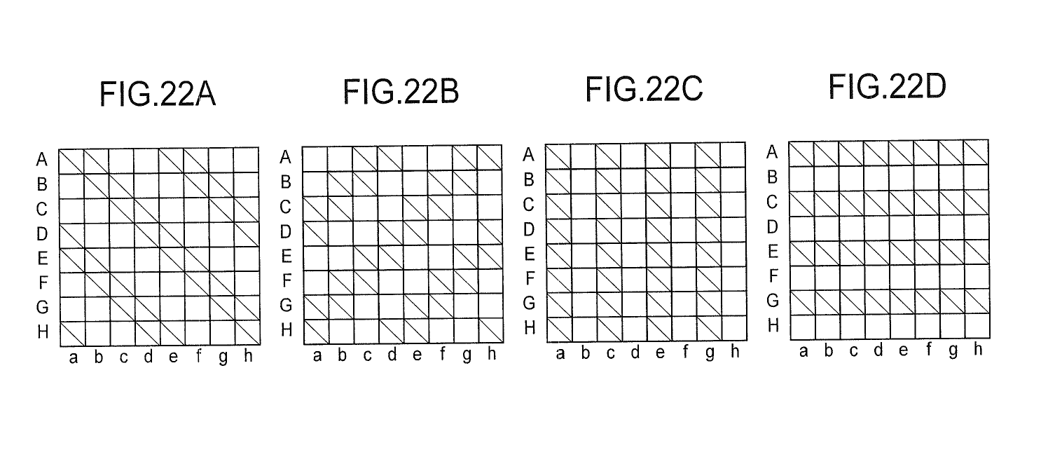

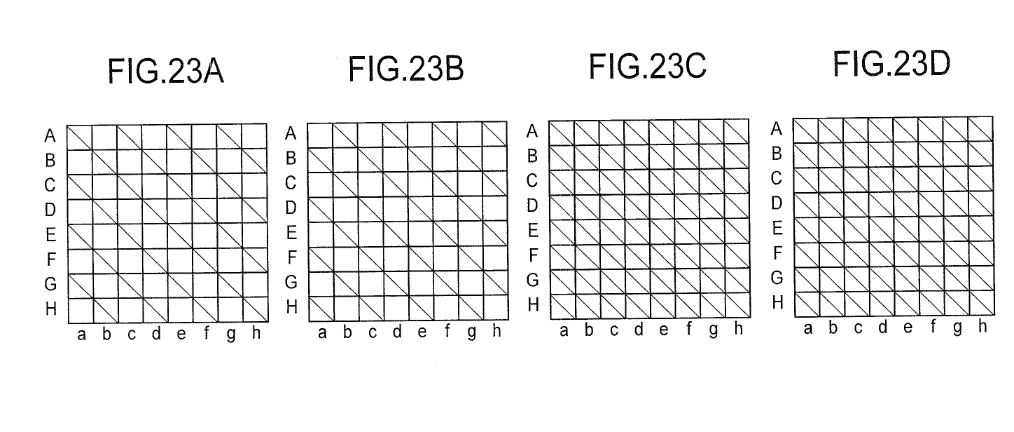

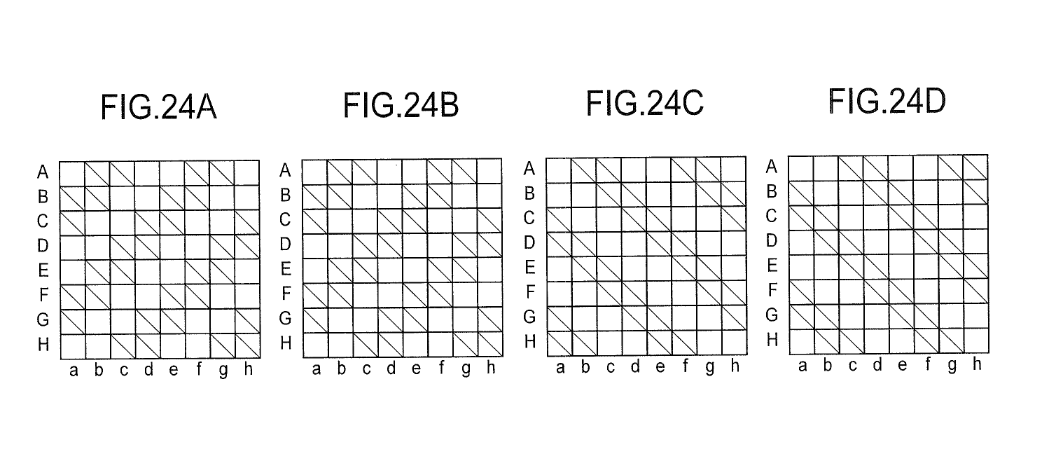

FIG. 21 is a pixel deployment diagram showing the arrangement of pixels on the image sensor 10 in the third embodiment. FIG. 22 is an in-r-difference diagram mapping the in-r-differences between each of the pixels and a neighboring pixel in the third embodiment. FIG. 23 is an in-r-difference diagram mapping the in-r-differences between each of the pixels and a first next-neighboring pixel in the third embodiment. FIG. 24 is an in-r-difference diagram mapping the in-r-differences between each of the pixels and a second next-neighboring pixel in the third embodiment.

FIG. 22A maps the in-r-differences between pixel pairs including a target pixel and a neighboring pixel arranged one row below the target pixel; FIG. 22B maps the in-r-differences between pixel pairs including a target pixel and a neighboring pixel arranged one column to the right of the target pixel; FIG. 22C maps the in-r-differences between pixel pairs including a target pixel and a neighboring pixel arranged one row above and one column to the right of the target pixel; and FIG. 22 maps the in-r-differences between pixel pairs including a target pixel and a neighboring pixel arranged one row below and one column to the right of the target pixel.

As shown in FIGS. 22A to 22D, among the pixel pairs comprising a target pixel and a neighboring pixel arranged in any direction from the target pixel, the number of pixel pairs having the in-r-difference is equal to the number of the pixel pairs having the same inside reflected OPL.

FIG. 23A maps the in-r-differences between pixel pairs including a target pixel and a first next-neighboring pixel arranged two rows below the target pixel; FIG. 23B maps the in-r-differences between pixel pairs including a target pixel and a first next-neighboring pixel arranged two columns to the right of the target pixel; FIG. 23C maps the in-r-differences between pixel pairs including a target pixel and a first next-neighboring pixel arranged two rows above and two columns to the right of the target pixel; and FIG. 23D maps the in-r-differences between pixel pairs including a target pixel and a first next-neighboring pixel arranged two rows below and two columns to the right of the target pixel, respectively.

As shown in FIGS. 23A and 23B, among the pixel pairs comprising a target pixel and a first next-neighboring pixel arranged two rows below or two columns to the right of the target pixel, the number of pixel pairs having the in-r-difference is equal to the number of pixel pairs having the same inside reflected OPL.

On the other hand, as shown in FIGS. 23C and 23D, among pixel pairs comprising a target pixel and first next-neighboring pixel arranged two rows above and two columns to the right of the target pixel or two rows below and two columns to the right of the target pixels, all pixel pairs have the in-r-differences.

Accordingly, in the third embodiment, among pixel pairs comprising a target pixel and a first next-neighboring pixel arranged in any directions from the target pixels, the ratio of pixel pairs having the in-r-difference to all pixel pairs is 75%, and the ratio of pixel pairs having the same inside reflected OPL to all pixel pairs is 25%.

FIG. 24A maps the in-r-differences between pixel pairs including a target pixel and a second next-neighboring pixel in the same arrangement as FIG. 16A; FIG. 24B maps the in-r-differences between pixel pairs including a target pixel and a second next-neighboring pixel in the same arrangement as FIG. 16B; FIG. 24C maps the in-r-differences between pixel pairs including a target pixel and a second next-neighboring pixel in the same arrangement as FIG. 16C; and FIG. 24D maps the in-r-differences between pixel pairs including a target pixel and a second next-neighboring pixel in the same arrangement as FIG. 16D.

As shown in FIGS. 24A to 24D, among the pixel pairs comprising a target pixel and a second next-neighboring pixel arranged in any direction from the target pixel, the number of pixel pairs having the in-r-difference is equal to the number of pixel pairs having the same inside reflected OPLs.

In the above third embodiment, the number of pixel pairs having in-r-differences of (m+1/2)×λ and comprising a target pixel and either a neighboring pixel, or second next-neighboring pixel in any direction from the target pixel is equal to the number of pixel pairs having the same inside reflected OPL. However, the number of pixel pairs having in-r-differences and comprising a target pixel and a first next-neighboring pixel in any direction from the target pixel in the third embodiment is greater than the number in the second embodiment.

In the above third embodiment, the contrast of the diffraction light based on the reflection at members located inside of the color filter layer 14 can be reduced by rearranging the pixel pairs with the in-r-differences to create phase differences between the reflected light from pairs of pixels that have the same color filter. By reducing the contrast of the diffraction light, the influence of the r-d-ghost image can be mitigated.

The third embodiment is different from the first embodiment, in that the number of pixel pairs having the in-r-difference among all of the pixel pairs comprising a target pixel and a first next-neighboring pixel is greater than the number of the pixel pairs having the same inside reflected OPL. And the ratio of the pixel pairs having the in-r-difference to all pixel pairs is greater than that in the second embodiment. Accordingly, the effect from reducing the influence of the r-d-ghost image in the third embodiment is less than those in the first and second embodiments. However, the influence of the r-d-ghost image can be sufficiently reduced in comparison to an image sensor having pixels with equal inside reflected OPLs.

Next, an image sensor of the fourth embodiment is explained. The primary difference between the fourth embodiment and the first embodiment is the arrangement of normal pixels and lengthened pixels. The fourth embodiment is explained mainly with reference to the structures that differ from those of the first embodiment. To simplify matters, the same index numbers from the first embodiment will be used for corresponding structures in the fourth embodiment.

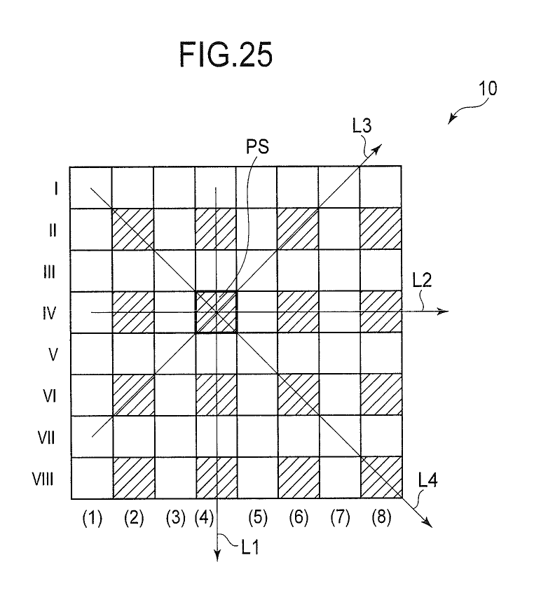

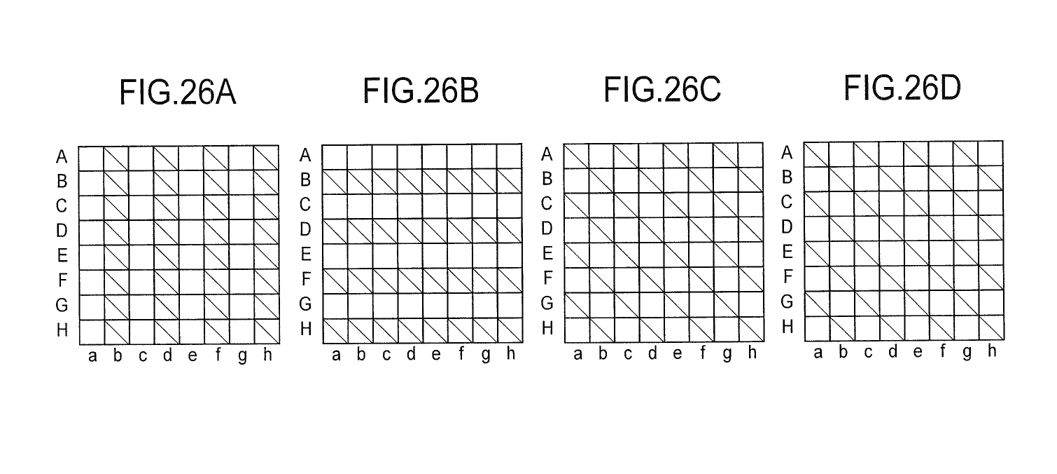

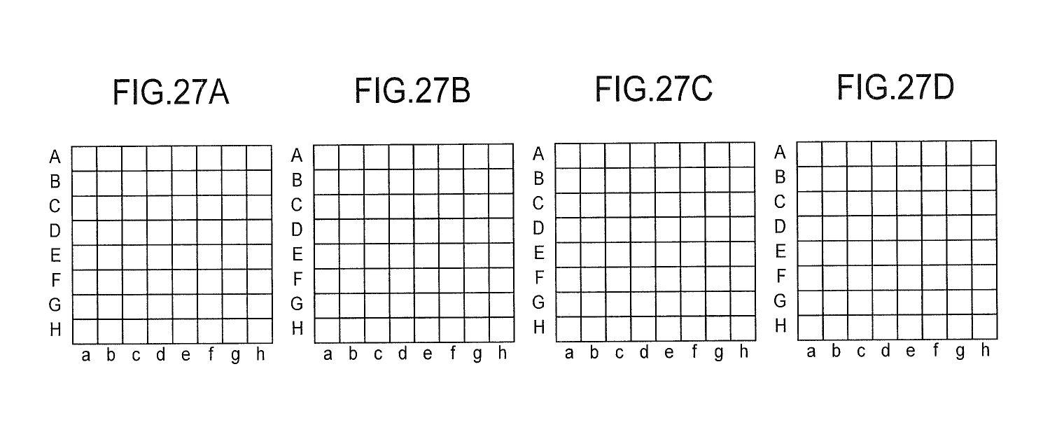

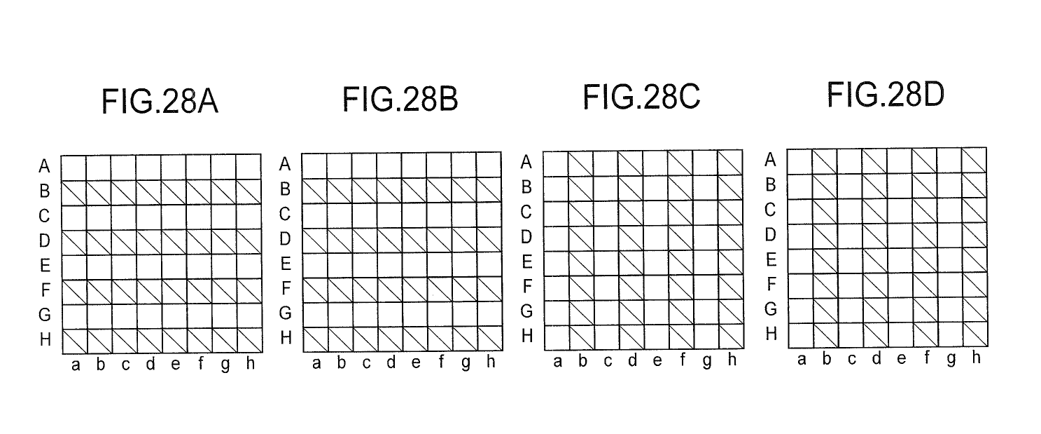

FIG. 25 is a pixel deployment diagram showing the arrangement of pixels on the image sensor 10 in the fourth embodiment. FIG. 26 is an in-r-difference diagram mapping the in-r-difference between each of the pixels and a neighboring pixel in the fourth embodiment. FIG. 27 is an in-r-difference diagram mapping the in-r-difference between each of the pixels and a first next-neighboring pixel in the fourth embodiment. FIG. 28 is an in-r-difference diagram mapping the in-r-difference between each of the pixels and a second next-neighboring pixel in the fourth embodiment.

FIG. 26A maps the in-r-differences between pixel pairs including a target pixel and a neighboring pixel arranged one row below the target pixel; FIG. 26B maps the in-r-differences between pixel pairs including a target pixel and a neighboring pixel arranged one column to the right of the target pixel; FIG. 26C maps the in-r-differences between pixel pairs including a target pixel and a neighboring pixel arranged one row above and one column to the right of the target pixel; and FIG. 26D maps the in-r-differences between pixel pairs including a target pixel and a neighboring pixel arranged one row below and one column to the right of the target pixel.

As shown in FIGS. 26A to 26D, among the pixel pairs comprising a target pixel and a neighboring pixel arranged in any direction from the target pixel, the number of pixel pairs having the in-r-difference is equal to the number of the pixel pairs having the same inside reflected OPL.

FIG. 27A maps the in-r-differences between pixel pairs including a target pixel and a first next-neighboring pixel arranged two rows below the target pixel; FIG. 27B maps the in-r-differences between pixel pairs including a target pixel and a first next-neighboring pixel arranged two columns to the right of the target pixel; FIG. 27C maps the in-r-differences between pixel pairs including a target pixel and a first next-neighboring pixel arranged two rows above and two columns to the right of the target pixel; and FIG. 27D maps the in-r-differences between pixel pairs including a target pixel and a first next-neighboring pixel arranged two rows below and two columns to the right of the target pixel.

As shown in FIGS. 27A to 27D, among the pixel pairs comprising a target pixel and a first next-neighboring pixel arranged in all directions from the target pixel, all pixel pairs have the same inside reflected OPLs.

FIG. 28A maps the in-r-differences between pixel pairs including a target pixel and a second next-neighboring pixel in the same arrangement as FIG. 16A; FIG. 28B maps the in-r-differences between pixel pairs including a target pixel and a second next-neighboring pixel in the same arrangement as FIG. 16B; FIG. 28C maps the in-r-differences between pixel pairs including a target pixel and a second next-neighboring pixel in the same arrangement as FIG. 16C; and FIG. 28D maps the in-r-differences between pixel pairs including a target pixel and a second next-neighboring pixel in the same arrangement as FIG. 16D.

As shown in FIGS. 28A to 28D, among the pixel pairs comprising a target pixel and a second next-neighboring pixel arranged in any direction from the target pixels, the number of pixel pairs having the in-r-difference is equal to the number of pixel pairs having the same inside reflected OPL.

In the above fourth embodiment, the contrast of the diffraction light based on the reflection at members located inside of the color filter layer 14 can be reduced by rearranging the pixel pairs with the in-r-differences to create phase differences between the reflected light from pairs of pixels that have the same color filter. By reducing the contrast of the diffraction light, the influence of the r-d-ghost image can be mitigated.

The fourth embodiment is different from the first embodiment, in that all pixel pairs have the same inside reflected OPL among pixel pairs comprising a target pixel and a first next-neighboring pixel. Accordingly, the effect from reducing the influence of the r-d-ghost image in the fourth embodiment is less than those in the first to third embodiments. However, the influence of the r-d-ghost image can be sufficiently reduced in comparison to an image sensor having pixels with equal inside reflected OPLs.

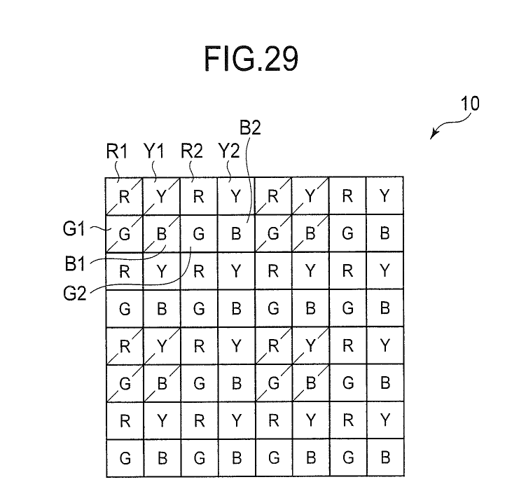

Next, an image sensor of the fifth embodiment is explained. The primary difference between the fifth embodiment and the first embodiment is the structure of the color filter layer. The fifth embodiment is explained mainly with reference to the structures that differ from those of the first embodiment using FIG. 29. To simplify matters, the same index numbers from the first embodiment will be used for corresponding structures in the fifth embodiment.

FIG. 29 is a deployment diagram showing the arrangement of the lengthened pixels and the normal pixels having each of red, yellow, green, and blue color filters on the image sensor in the fifth embodiment. In FIG. 29, there are in-r-differences between the pixels indicated by the white panels and the pixels indicated by panels marked with a diagonal line.

In the fifth embodiment, the color filter layer 14 of the image sensor 10 comprises red, yellow, green, and blue color filters. The ranges of the wavelengths of light that can pass through the red, yellow, green, and blue color filters are different. Among the arranged pixels having red color filters, the lengthened pixels have a λ/2 in-r-difference from the normal pixels (λ being a middle value of the range of wavelengths of light that can pass through the red color filter). Among the arranged pixels having yellow color filters, the lengthened pixels have a λ/2 in-r-difference from the normal pixels (λ being a middle value of the range of wavelengths of light that can pass through the yellow color filter). Among the arranged pixels having green color filters, the lengthened pixels have a λ/2 in-r-difference from the normal pixels (λ being a middle value of the range of wavelengths of light that can pass through the green color filter). Among the arranged pixels having blue color filters, the lengthened pixels have a λ/2 in-r-difference from the normal pixels (λ being a middle value of the range of wavelengths of light that can pass through the blue color filter).

The wavelength of light that can pass through the red color filter ranges between 600 nm and 700 nm. Accordingly, first and second red pixels R1 and R2 with an in-r-difference of 325 nm between them are arranged. The wavelength of light that can pass through the yellow color filter ranges between 530 nm and 630 nm. Accordingly, first and second yellow pixels Y1 and Y2 with an in-r-difference of 290 nm between them are arranged.

The wavelength of light that can pass through the green color filter ranges between 470 nm and 570 nm. Accordingly, first and second green pixels G1 and G2 with an in-r-difference of 260 nm between them are arranged. The wavelength of light that can pass through the blue color filter ranges between 400 nm and 500 nm. Accordingly, first and second blue pixels B1 and B2 with an in-r-difference of 225 nm between them are arranged.

In the image sensor 10 of the fifth embodiment, the lengthened and normal r-pixels are arranged in the same arrangement as the first embodiment (see FIG. 13). In addition, the lengthened and normal yellow pixels, hereinafter referred to as y-pixels, are arranged in the same arrangement as the first embodiment. In addition, the lengthened and normal g-pixels are arranged in the same arrangement as the first embodiment. In addition, the lengthened and normal b-pixels are arranged in the same arrangement as the first embodiment.

In the above fifth embodiment, even though the image sensor 10 comprises a color filter layer of which color filters are arranged according to a method that is different from the Bayer color array, the contrast of the diffraction light based on the reflection at members located inside of the color filter layer 14 can be reduced by rearranging the pixel pairs with the in-r-differences to create phase differences between the reflected light from pairs of pixels that have the same color filter. By reducing the contrast of the diffraction light, the influence of the r-d-ghost image can be mitigated.

Next, an image sensor of the sixth embodiment is explained. The primary difference between the sixth embodiment and the first embodiment is the structure of the color filter layer and the arrangement of the lengthened pixels. The sixth embodiment is explained mainly with reference to the structures that differ from those of the first embodiment. To simplify matters, the same index numbers from the first embodiment will be used for corresponding structures in the sixth embodiment.

In the sixth embodiment, the arrangement of the red, yellow, green, and blue color filters in the color filter layer 14 and the arrangement of the lengthened pixels and the normal pixels are the same as those in the fifth embodiment (see FIG. 29). However, the sixth embodiment is different from the fifth embodiment in that the in-r-difference produced for pairs of r-pixels, y-pixels, g-pixels, and b-pixels is 300 nm and independent of the wavelength band of light that passes through the individual color filters.

Using λr (=650 nm), which is the middle wavelength of the 600 nm-700 nm wavelength band of red light, the in-r-difference of 300 nm is about 0.46×λr. Using λy (=580 nm), which is the middle wavelength of the530 nm-630 nm wavelength band of yellow light, the in-r-difference of 300 nm is about 0.52×λy.

Using λg, (=520 nm) which is the middle wavelength of the 470 nm-570 nm wavelength band of green light, the in-r-difference of 300 nm is about 0.58×λg. Using λb (=450 nm), which is the middle wavelength of the 400 nm-500 nm wavelength band of blue light, the in-r-difference of 300 nm is about 0.67×λb.

Accordingly, the in-r-differences for the pairs of r-pixels, y-pixels, g-pixels, and b-pixels are not (m+1/2)×(representative wavelength for each color). However, even if the in-r-difference is calculated with the same wavelength, phase differences can be created between the reflected light from pairs of r-pixels, y-pixels, g-pixels, and b-pixels. Consequently, the influence of the r-d-ghost image can be mitigated.

In the sixth embodiment, the in-r-difference for all colors is determined to be 300 nm. However, the in-r-difference that is created to be equal for all colors is not limited to 300 nm. The band of wavelengths of the incident light that reaches the photoelectric conversion layer 12 includes visible light. Assuming that λa is a wavelength that is approximately the same as the middle wavelength in the band of visible light, the desired in-r-difference or a practical difference in the thickness would be (m+1/2)×λa. For example, the in-r-difference or the practical difference in the thickness can be determined from the range from 200 nm to 350 nm. In particular, the in-r-difference is desired to be from 250 nm to 300 nm.

In addition, in the sixth embodiment, the in-r-difference can be created between the reflected light from pairs of pixel blocks having r-, y-, g-, and b-pixels arranged in two rows and columns since the in-r-differences to be created between the reflected light from pairs of r-, and b-pixels are equal. By creating the in-r-difference between the reflected light from pairs of pixel blocks, the influence of a gap between the ideal position and the practical set position of the micro lenses to the pixels can be reduced. In the Bayer color array, the thicknesses of the r- and b-pixels that are vertically and horizontally adjacent to a certain g-pixel are equal to the thickness of the g-pixel.

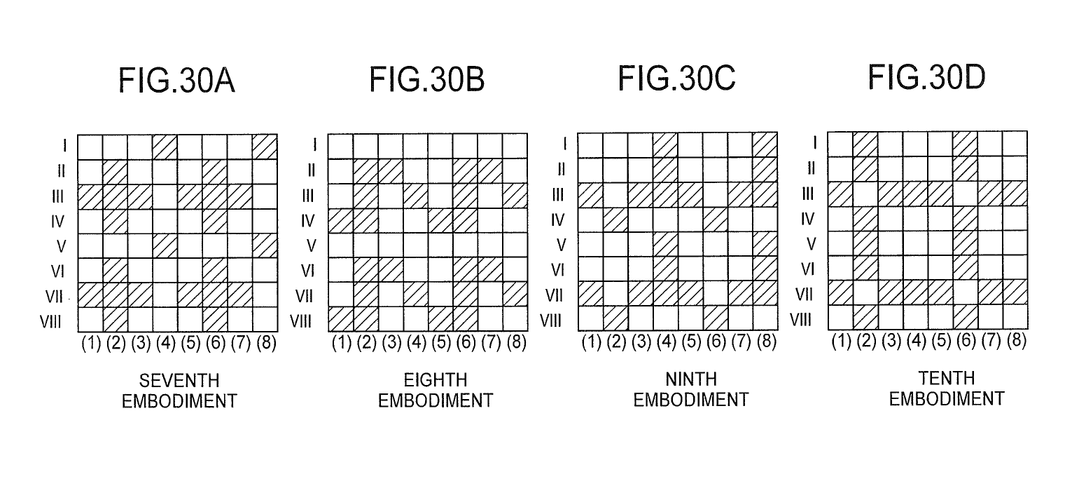

Next, image sensors of the seventh to tenth embodiments are explained. In the seventh to tenth embodiments, the arrangement of the lengthened pixels and the normal pixels is different from the arrangement in the first embodiment, as shown in FIG. 30. However, in the seventh to tenth embodiments, the number of pixel pairs comprising target pixels and either neighboring pixels, first next-neighboring pixels, or second next-neighboring pixels for all directions and having the in-r-difference of (m+1/2)×λ is equal to the number of pixel pairs having the same inside reflected OPL, similar to the first embodiment. Accordingly, the r-d-ghost image can be reduced in the seventh to tenth embodiments, similar to the first embodiment.

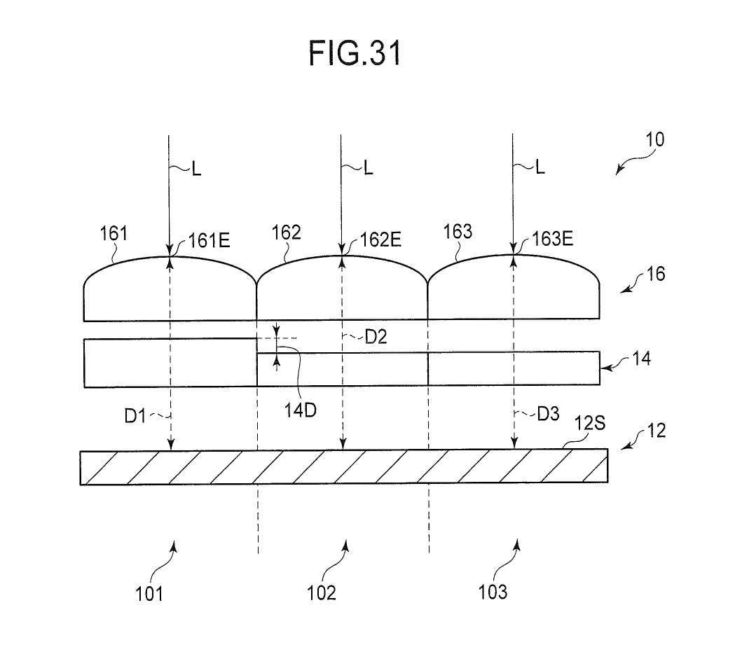

Next, an image sensor of the eleventh embodiment is explained. The primary difference between the eleventh embodiment and the first embodiment is the method for creating the in-r-difference between a pair of pixels. The eleventh embodiment is explained using FIG. 31 mainly with reference to the structures that differ from those of the first embodiment. FIG. 31 is a sectional view of the image sensor of the eleventh embodiment. To simplify matters, the same index numbers from the first embodiment will be used for corresponding structures in the eleventh embodiment.

In the eleventh embodiment, the in-r-differences are created by changing the thickness of the color filter per each pixel. As shown in FIG. 31, a difference (see “14D”) in the thickness of color filters exists between the first pixel 101 and the second and third pixels 102, 103. The difference in the thickness multiplied by 2 times the difference between the refractive indexes of the color filter and air becomes the in-r-difference between a pair of the first and second pixels 101, 102. If a liquid or resin is filled in the space between the color filter layer 14 and micro-lens array 16 instead of air, the in-r-difference is calculated using the refractive index of the liquid or resin instead of the refractive index of air.

In the above eleventh embodiment, the in-r-difference can be created between pairs of pixels by changing the thickness of the color filters instead of the thickness of the micro lens. Accordingly, similar to the first embodiment, the influence of the r-d-ghost image can be reduced.

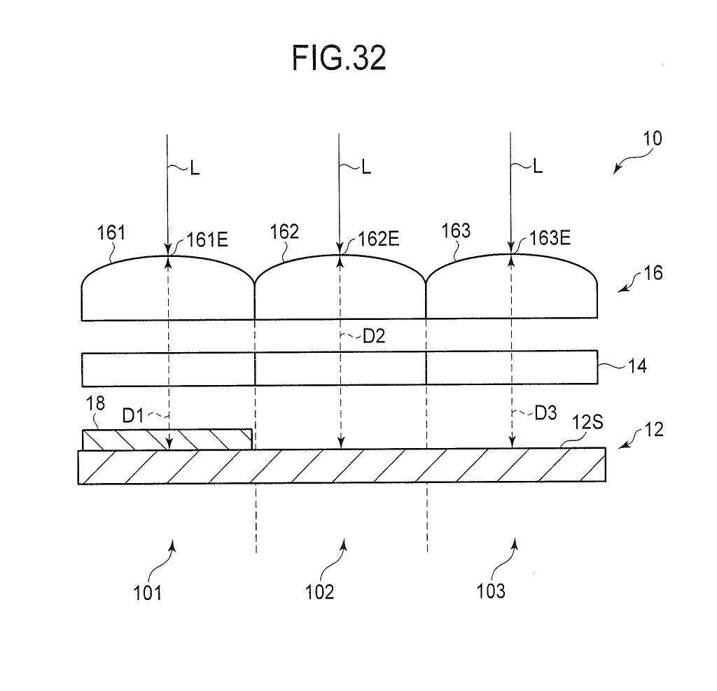

Next, an image sensor of the twelfth embodiment is explained. The primary difference between the twelfth embodiment and the first embodiment is the method for creating the in-r-difference between a pair of pixels. The twelfth embodiment is explained using FIG. 32 mainly with reference to the structures that differ from those of the first embodiment. FIG. 32 is a sectional view of the image sensor of the twelfth embodiment. To simplify matters, the same index numbers from the first embodiment will be used for corresponding structures in the twelfth embodiment.

As shown in FIG. 32, in the twelfth embodiment, a transmissible plate 18 is mounted on the light-receiving area 12S of the photoelectric converter for only part of pixels, for example a first pixel 101. By mounting the transmissible plate 18, the inside reflected OPL is lengthened. Accordingly, the transmissible plates are mounted only at the photoelectric converter for the same pixels that are lengthened pixels in the first to tenth embodiments.

In the twelfth embodiment, the thickness of the transmissible plate 18 multiplied by 2 times the difference between the refractive indexes of the transmissible plate 18 and air becomes the in-r-difference between the pair of first and second pixels 101, 102.

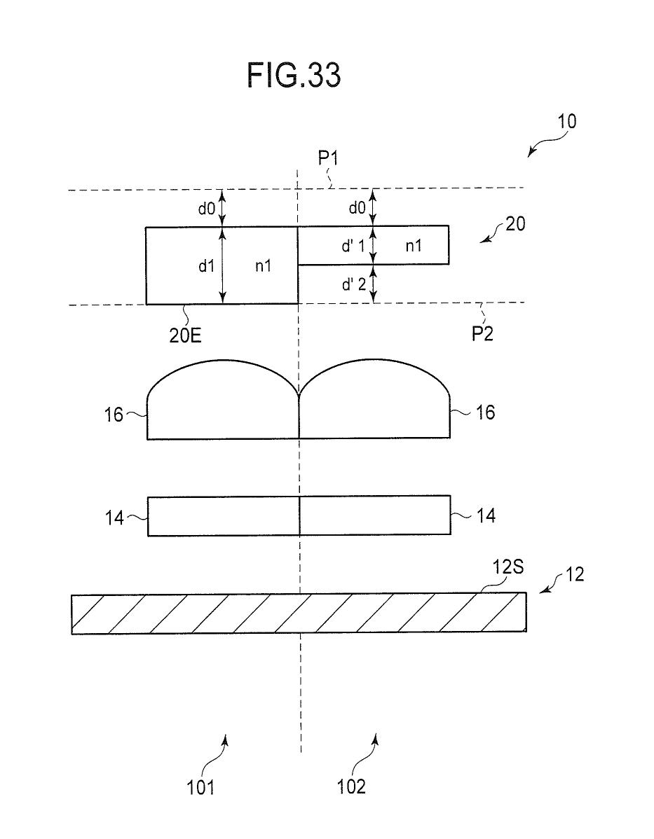

The position of the transmissible plate 18 is not limited to the inside of the image sensor 10. For example, in the thirteenth embodiment as shown in FIG. 33, instead of the transmissible plate 18 a phase plate 20 can be mounted above the micro-lens array 16 to lengthen the individually different OPLs for pixels.

In the thirteenth embodiment, the thickness of the micro lenses is the same for all pixels, which is different from the first embodiment. In addition, the phase plate 20 mounted in the thirteenth embodiment is also different from the first embodiment.

The phase plate 20 is mounted further from the photoelectric conversion layer 12 than the micro-lens array 16. The phase plate 20 is formed so that the thickness at each pixel is either one of two thicknesses. In addition, the phase plate 20 has flat and uneven surfaces. The phase plate 20 is positioned so that the uneven surface faces the photoelectric conversion layer 12. By mounting the phase plate 20, the in-r-differences are created between pairs of pixels.

The OPLs from the photoelectric conversion layer 12 to a second plane (see “P2” in FIG. 33) that is aligned with the convex portion 20E of the phase plate 20 and is parallel to the light-receiving area of the photoelectric conversion layer 12 are equal for all pixels. Accordingly, the in-r-difference is calculated by multiplying the difference in the OPL from the imagined plane (see “P1”) to the second plane by two.

The OPL of the first pixel 101 from the imagined plane to the second plane is (d0×1)+(d1×n1). The OPL of the second pixel 102 from the imagined plane to the second plane is (d0×1)+(d′1×n1)+(d′2×1). The in-r-difference is the difference between the OPLs of the first and second pixels 101, 102 multiplied by two. Using the equation d′1+d′2=d1, the in-r-difference between the first and second pixels 101, 102 is calculated to be d′2×(n1−1).

In the above thirteenth embodiment, the in-r-differences between pairs of pixels can be created by mounting the phase plate 20. Accordingly, similar to the first embodiment, the influence of the r-d-ghost image can be reduced.

The inside structure of the image sensor 10 with the increased OPL inside the micro-lens array 16 makes it difficult to prevent diffused reflection. The in-r-differences can be created for such an image sensor 10 by adopting the above thirteenth embodiment.

In the above first to thirteenth embodiments, the influence of the r-d-ghost image generated by the reflection at the photoelectric conversion layer 12 can be reduced. However, the reduced influence is not limited to the r-d-ghost image generated by the reflection at the photoelectric conversion layer 12. A reduction in the influence of the r-d-ghost image generated by the reflection at the external or internal surfaces of any components mounted between an optical member, which changes the OPL, and the photoelectric conversion layer 12 is also possible. The component may be electrical wiring, for example. In addition, the optical member that changes the OPL is, for example, a micro lens (in the first to tenth embodiments), a color filter (in the eleventh embodiment), a transmissible plate (in the twelfth embodiment), or a phase plate (in the thirteenth embodiment).

In the above first to tenth embodiments, by changing the thickness of the micro lenses, the influence of the r-d-ghost image generated by the reflection not only at the photoelectric conversion layer 12 but also at the internal surface of the micro lenses can be reduced.

The OPL of light that travels from the imagined plane to the internal surface and is reflected by the internal surface back to the imagined plane is defined as an internal reflected OPL. The difference in the internal reflected OPL between pairs of pixels, hereinafter referred to as the i-r-difference, is equal to the in-r-difference. Accordingly, by changing the thickness of the micro lenses for individual pixels, the i-r-difference can be created to coincide with the in-r-difference.

Even if the thickness of the micro-lens array is even, the i-r-difference can be created by changing at least one of the distances from the photoelectric conversion layer 12 to the external and internal surfaces of the micro-lens array 16.

In addition, by changing the distance of the external surface of the micro lenses from the photoelectric conversion layer 12 as in the first to tenth embodiments, the influence of the r-d-ghost image generated by the reflection at the external surface of the micro-lens array 16 can also be reduced.

By changing the distance of the external surface of the micro lenses from the photoelectric conversion layer 12, the difference in the OPLs of light that travels from the imagined plane to the external surface and is reflected by the external surface back to the imagined plane between pixels, hereinafter referred to as the e-r-difference, can be created. Accordingly, the influence of the r-d-ghost image generated by the reflection at the external surface of the micro-lens array 16 can be reduced.

The arrangement of the color filters is not limited to the arrangement in the first to thirteenth embodiments. For an image sensor of which color filters are arranged according to any color array except the Bayer color array, the lengthened pixels are mixed so that the in-r-differences can be created between the target pixel and the neighboring pixel, or the first or second next-neighboring pixels.

However, if the specified color filter is not arranged in a matrix, a pixel that is nearest to a particular pixel having the same color filter may be considered as the neighboring pixel, and the in-r-difference can therefore be created between the pixel and the neighboring pixel.

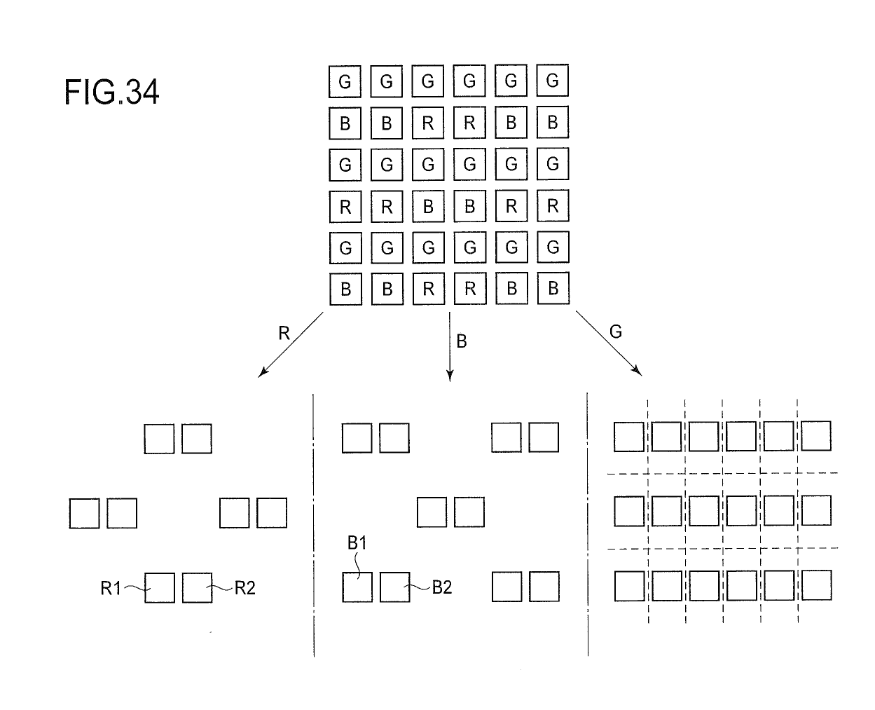

For example, as shown in FIG. 34, r-pixels and b-pixels are alternately arranged in the same rows. Accordingly, it is sufficient to create the in-r-difference between pairs of pixels that are nearest to each other. For r-pixels, the in-r-differences may be created between first and second r-pixels R1, R2 that are nearest to each other, as in the first to thirteenth embodiments. It is unnecessary to create the in-r-difference between the first r-pixel R1 and an r-pixel that is further from the first r-pixel R1 than the second r-pixel R2. However, an r-pixel that is further from the first r-pixel R1 than the second r-pixel R2 can be considered as a next-neighboring pixel for the first r-pixel R1 and the in-r-differences can be created between the r-pixel and the first r-pixel R1, as in the first to fourth embodiments. The arrangement of the lengthened pixels for b-pixels is similar to the arrangement for r-pixels.

The structure of the image sensor 10 is not limited to that in the above embodiments. For example, not only a color image sensor but also a monochrome image sensor can be adopted for these embodiments. When the image sensor is a color image sensor, the lengthened pixels are arranged so that the pixel units as in the first to fourth embodiments are formed individually for r-, g-, and b-pixels. On the other hand, when the image sensor is a monochrome image sensor, the lengthened pixels are arranged so that the pixel units as in the first to fourth embodiments are formed for entire pixels independently of the color filters.

In addition, for an image sensor where photoelectric converters that detect quantities of light having different wavelength bands, such as red, green, and blue light, are layered for all of the pixels, the lengthened pixels and the normal pixels can be mixed and arranged similar to the above embodiments. In the image sensor, hereinafter referred to as the multi-layer image sensor, the lengthened pixels may be arranged so that pixel units as shown in the first to fourth embodiments are formed for entire pixels independently of the color filters.

Because it is common for the diffraction angle in the multi-layer image sensor to be greater than that for other types of image sensors, image quality can be greatly improved by mixing the arrangement of the lengthened pixels and normal pixels. In this case, it is preferable that the in-r-difference is determined according to the wavelength of whichever light can be detected by the photoelectric converter mounted at the deepest point from the incident end of the image sensor, such as the wavelength of red light. A light component that is reflected at the two photoelectric converters above the deepest one, which is red light in this case, generates more diffraction light than the other light components that are absorbed by the photoelectric converters above the deepest one.

The in-r-difference to be created between pairs of pixels on the image sensor 10 is desired to be (m+1/2)×λ (m being an integer and λ being the wavelength of incident light) for the simplest pixel design. However, the in-r-difference is not limited to (m+1/2)×λ.

For example, the length added to the wavelength multiplied by an integer is not limited to half of the wavelength. One-half of the wavelength multiplied by a coefficient between 0.5 and 1.5 can be added to the product of the wavelength and an integer. Accordingly, the micro-lens array 16 can be formed so that the in-r-difference is between (m+1/4)×λ and (m+3/4)×λ.

In addition, the micro-lens array 16 can be formed so that the in-r-difference is (m+1/2)×λb (where λb is between 0.5λc<λb<1.5λc and λc is a middle wavelength value of a band of light that reaches the photoelectric converter).

In addition, the micro-lens array 16 can be formed so that the in-r-difference is (m+1/2)×λb (where λb is between 0.5λe<λb<1.5λe and λe is a middle wavelength value of a band of light that passes through each of the color filters).

The preferable value for the in-r-difference is for example (m+1/2)×λ, where m is an integer. However, if the in-r-difference is too great, it could cause a manufacturing error to occur. Accordingly, the absolute value of m is preferred to be not too great. For example, m is preferable to be greater than or equal to −2 and less than or equal to 2.

In addition, it is preferable that the number of pixel pairs having the in-r-difference of (m+1/2)×λ is equal to the number of pixel pairs with inside reflected OPLs that are equal between the target pixel and either the neighboring pixel or the first or second next-neighboring pixel, as in the first embodiment.

However, even if the number of pixel pairs having the in-r-difference is different from the number of pixel pairs having the same inside reflected OPLs, the influence of the r-d-ghost image can be sufficiently reduced compared to the image sensor in which all pixels have the same inside reflected OPLs, as in the second to fourth embodiments.

### EXAMPLES

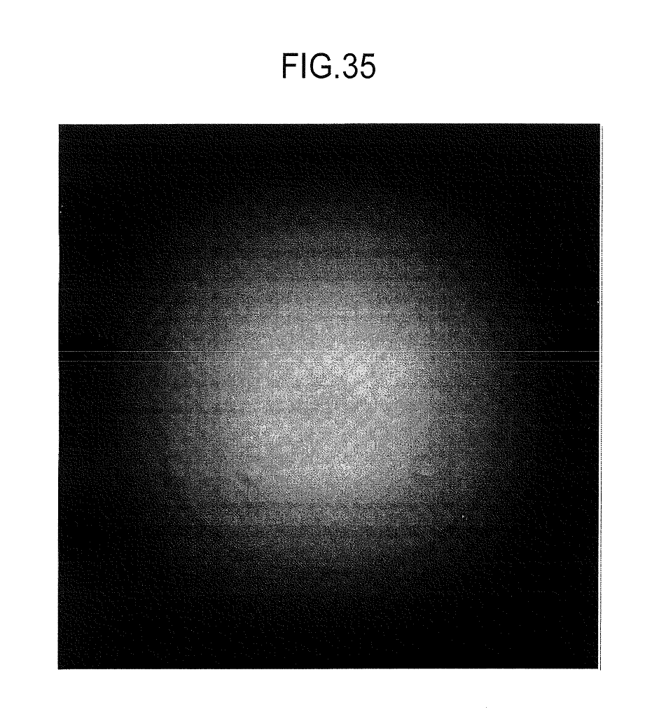

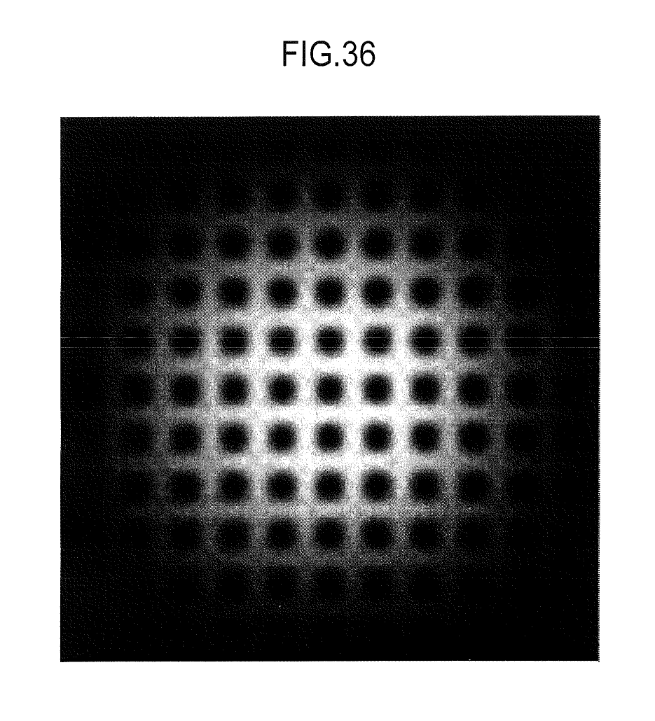

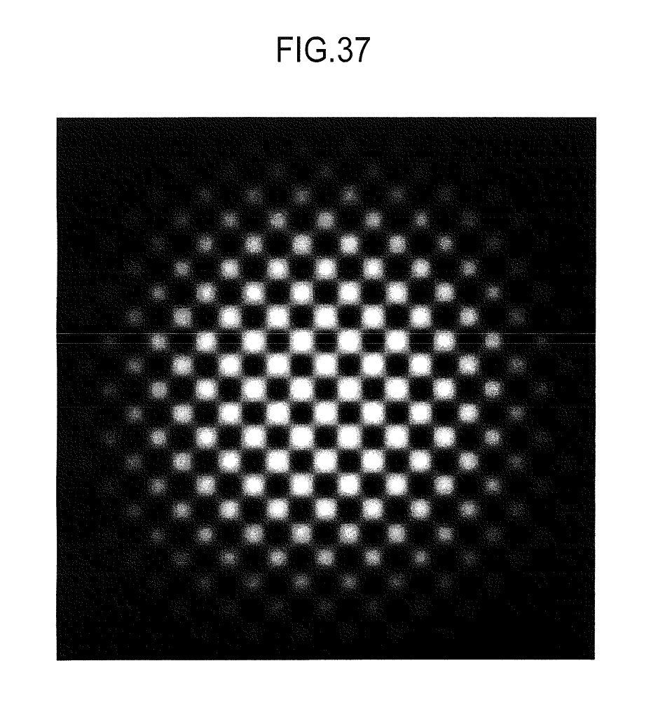

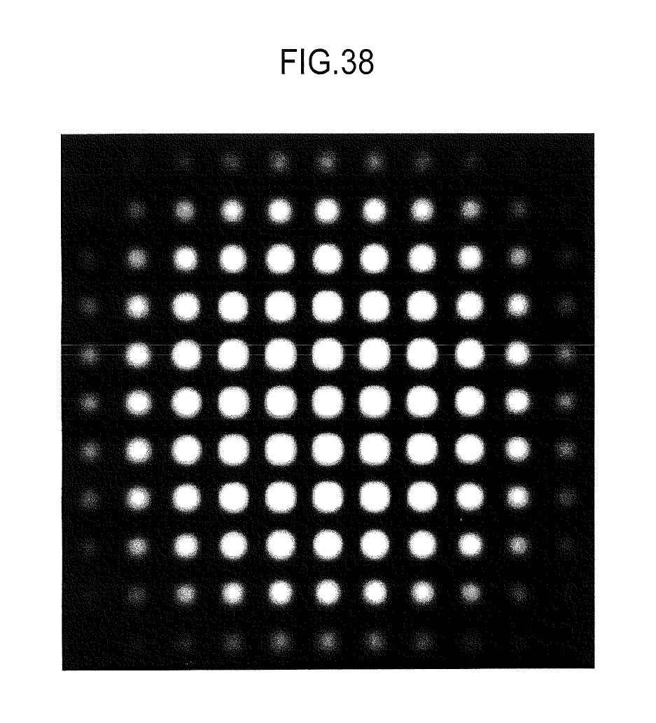

Next, this embodiment is explained with regard to the concrete arrangement of the lengthened pixels and the normal pixels and the effect below, with reference to following examples using FIGS. 35-39. However, this embodiment is not limited to these examples.

In the first to fourth examples, the lengthened pixels and the normal pixels were arranged as in the first to fourth embodiments, respectively. In addition, in the first comparative example, the inside reflected OPLs were the same for all pixels. Accordingly, phase differences were not created between all pixel pairs in the first comparative example.

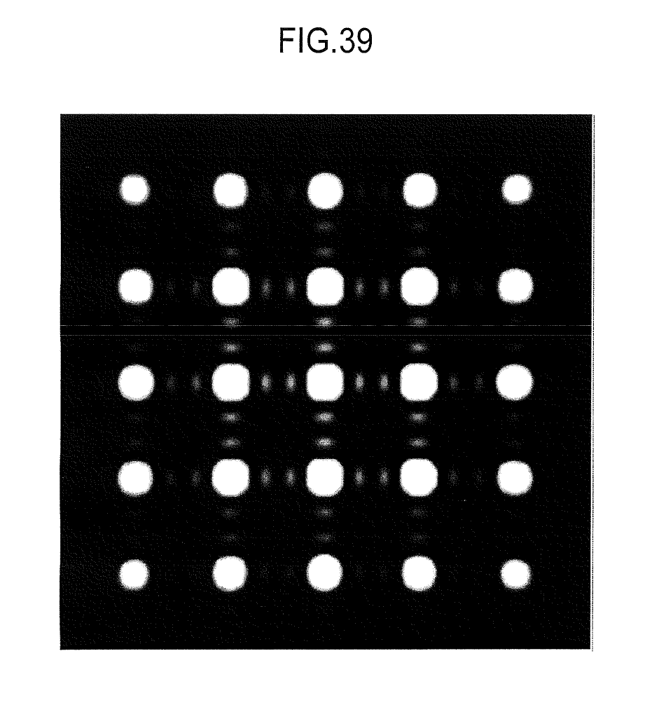

FIGS. 35-38 show the contrast of the diffraction light of the first to fourth examples, respectively. FIG. 39 shows the contrast of the diffraction light of the first comparative example.

Under the assumption that the contrast of the diffraction light in the first comparative example is 1, the relative contrast of the diffraction light in the above first to fourth examples has been calculated and presented in table 1.

TABLE 1

| | Relative Contrast |
|---|---|
| First Example | 0.004 |
| Second Example | 0.076 |
| Third Example | 0.139 |
| Fourth Example | 0.288 |
| Comparative Example | 1.000 |

As shown in FIGS. 35-39 and the above table 1, the contrast values in the first to fourth examples are much lower than the contrast in the comparative example. Accordingly, it is recognized that the contrast of the diffraction light can be reduced sufficiently by rearranging the lengthened and normal pixels, as in the first to fourth examples.

It is estimated that a diffraction angle of one-half the diffraction angle of the first comparative example would be obtained by changing the directions of some parts of the diffraction light, thereby reducing the contrast of the full quantity of diffraction light. It is also estimated that the variation of the diffraction angle of the diffraction light generated between a target pixel and a neighboring pixel contributes to the reduction in contrast because the neighboring pixel is nearest to the target pixel.

As shown in FIGS. 35-38 and in Table 1, the contrast is lowest for the first embodiment and increases in order for the second, third, and fourth embodiments.

Out of all pixels, the percentages of pixel pairs having in-r-differences between a target pixel and either a first or second next-neighboring pixel are 50%, 56.2%, 62.5%, and 25% in the first, second, third, and fourth examples, respectively. The absolute values of the differences between the above percentages and 50% are 0%, 6.2%, 12.5%, and 25%, respectively. Accordingly, it is recognized that the contrast can be reduced by a proportionately greater amount as the ratio of pixel pairs with the in-r-differences comprising a target pixel and either a first or second next-neighboring pixel to all pixels approaches 50%.

The interference of the diffraction light appears not only between a target pixel and a neighboring pixel but also between a target pixel and a next-neighboring pixel. Accordingly, it is estimated that the contrast can be reduced by a proportionately greater amount as the ratio of pixel pairs comprising a target pixel and next-neighboring pixel to all pixels approaches 50%.

It is estimated that 50% of all pixels is the preferred percentage for the number of pixel pairs comprising a target pixel and a second next-neighboring pixel that have the in-r-difference.

However, a sufficient reduction in contrast was confirmed in the above examples. Accordingly, it is recognized that the contrast can be reduced as long as pixel pairs comprising a target pixel and either a first or second next-neighboring pixel are mixed between those having the in-r-differences and those having the same inside reflected OPL.

In addition, it is clear from the above examples that the contrast can be sufficiently reduced, at minimum, by mixing the pixel pairs comprising a target pixel and either a first or second next-neighboring pixel that have the in-r-differences so that the ratio of pixel pairs having the in-r-differences to all pixels is between 25%-75%.

Next, the fifth and sixth examples and the second comparative example are used to demonstrate that the influence of the r-d-ghost image can be reduced even if the in-r-differences are constant values independent of a different band of wavelengths.

The same color filter layers from the fifth and sixth embodiments were used in the fifth and sixth examples, and the normal and lengthened pixels were arranged individually for each color filter. The same color filter layers from the fifth and sixth embodiments were also used in the second comparative example. However, in the second comparative example the inside reflected OPLs are equal for all pixels.

Under the assumption that the contrast of the diffraction light in the second comparative example is 1, the relative contrast was calculated for the diffraction light in the above fifth and sixth examples. For the sixth example, the relative contrasts were calculated individually for each color. The relative contrast in the fifth embodiment is 0.288. The relative contrasts of the r-pixel, y-pixel, g-pixel, and b-pixel in the sixth embodiment are 0.322, 0.311, 0.357 and 0.483, respectively.

Comparison of the fifth and sixth examples indicates that the reduction in the contrast of the diffraction light generated at an image sensor with constant in-r-differences independent of filter color is less than the reduction for an image sensor with in-r-differences that vary according to filter color. However, comparing the sixth embodiment with the second comparative embodiment indicates that the contrast can be reduced sufficiently even if the in-r-differences are constant and independent of filter color.

Although the embodiments of the present invention have been described herein with reference to the accompanying drawings, obviously many modifications and changes may be made by those skilled in this art without departing from the scope of the invention.

The present disclosure relates to subject matters contained in Japanese Patent Applications No. 2009-157234 (filed on Jul. 1, 2009) and No, 2010-144073 (filed on Jun. 24, 2010), which are expressly incorporated herein, by references, in their entireties.

1. An image sensor comprising a plurality of first pixels that comprise photoelectric converters and first optical members, the first optical member covering the photoelectric converter, light incident on the photoelectric converter passing through the first optical member, the first pixels being arranged on a light-receiving area,
first differences being created for the thicknesses of the first optical members in two of the first pixels in a part of first pixel pairs among all first pixel pairs, the first pixel pair including two of the first pixels selected from the plurality of said first pixels.

2. An image sensor according to claim 1, wherein the first optical member is a micro lens that condenses light incident on the first pixel.

3. An image sensor according to claim 2, wherein the distances from the photoelectric converter to a far-side surface of the micro lens are different between two of the first pixels in which the first differences are created for the thickness of the first optical members, a far-side surface is an opposite surface of a near-side surface, the near-side surface of the first optical member faces the photoelectric converter.

4. An image sensor according to claim 1, wherein the first optical member is a first optical filter, a portion of the total light incident on the first pixel having a first wavelength band and passing through the first optical filter.

5. An image sensor according to claim 1, wherein the first optical member is mounted on the light-receiving area of the photoelectric converter.

6. An image sensor according to claim 1, wherein the first difference is greater than ½×(m1+¼)×λ1/(n11−n12) and less than ½×(m1+¾)×λ1/(n11−n12), m1 is an integer, λ1 is a wavelength around the middle value of a band of wavelengths of light that is assumed to be made incident on the photoelectric converter, n11 is a refractive index of the first optical member, n12 is the refractive index of air or the refractive index of a substance filling a space to create the first distance.

7. An image sensor according to claim 1, wherein the first difference is greater than (½×(½)×λ1/(n11−n12))×½ and less than (½×(½)×λ1/(n11−n12))× 3/2, λ1 is a wavelength around the middle value of a band of wavelengths of light that is assumed to be made incident on the photoelectric converter, n11 is a refractive index of the first optical member, n12 is the refractive index of air or a refractive index of a substance filling a space to create the first distance.

8. An image sensor according to claim 1, wherein the first pixel comprises a first optical filter, a portion of the total light incident on the first pixel having a first wavelength band and passing through the first optical filter,
the first difference is greater than ½×(m1+¼)×λ2/(n11−n12) and less than ½×(m1+¾)×λ2/(n11−n12), m1 is an integer, λ2 is the middle value of the first wavelength band, n11 is a refractive index of the first optical member, n12 is the refractive index of air or a refractive index of a substance filling a space to create the first distance.

9. An image sensor according to claim 1, wherein the first pixel comprises a first optical filter, a portion of the total light incident on the first pixel having a first wavelength band and passing through the first optical filter,
the first difference is greater than (½×(½)×λ2/(n11−n12))×½ and less than (½×(½)×λ2/(n11−n12))×3/2, λ2 is the middle value of the first wavelength band, n11 is a refractive index of the first optical member, n12 is the refractive index of air or a refractive index of a substance filling a space to create the first distance.

10. An image sensor according to claim 6, wherein m1 is one of −2, −1, 0, 1, or 2.

11. An image sensor according to claim 1, wherein the first difference is between 200 nm and 350 nm.

12. An image sensor according to claim 11, wherein the first difference is between 250 nm and 300 nm.

13. An image sensor according to claim 1, wherein the first pixel pairs having the first difference are arranged cyclically along a predetermined direction on the light-receiving area.

14. An image sensor according to claim 13, wherein the number of first pixel pairs having the first difference is equal to the number of first pixel pairs not having the first difference in the predetermined direction, the first pixel pair is a first target pixel and a first neighboring pixel, the first target pixel is the first pixel selected one-by-one among the plurality of first pixels, the first neighboring pixel is the first pixel positioned nearest to the first target pixel.

15. An image sensor according to claim 1, wherein,
the first pixels are arranged in two dimensions,
the number of first pixel pairs having the first difference is substantially equal to the number of first pixel pairs, the first pixel pair is a first target pixel and a first neighboring pixel arranged along one direction from the first target pixel, the first target pixel is the first pixel selected one-by-one among the plurality of first pixels, the first neighboring pixel is any one of the eight first pixels positioned nearest to the first target pixel in the eight directions from the first target pixel.

16. An image sensor according to claim 1, wherein,
the first pixels are arranged in two dimensions,
the number of first pixel pairs having the first difference is substantially equal to the number of first pixel pairs, the first pixel pair is a first target pixel and a first next-neighboring pixel arranged along one direction from the first target pixel, the first target pixel is the first pixel selected one-by-one among the plurality of first pixels, the first next-neighboring pixel is any one of the sixteen first pixels positioned nearest to and surrounding the eight first neighboring pixels, the first neighboring pixel is any one of the eight first pixels positioned nearest in eight direction from the first target pixel.

17. An image sensor according to claim 1, wherein,
the first pixels are arranged in two dimensions,
the number of first pixel pairs having the first difference is substantially equal to the number of first pixel pairs in a first pixel unit, the first pixel pair is a first target pixel and a first pixel nearest to the first target pixel in a predetermined direction, the first pixel unit includes sixteen of the first pixels arranged along four first lines and four second lines, the first target pixel is the first pixel selected one-by-one among the plurality of first pixels, the first and second lines are perpendicular to each other,
a plurality of the first pixel unit is mounted on the image sensor.

18. An image sensor according to claim 1, wherein,
the photoelectric converter comprises first and second photoelectric converters, the first and second photoelectric converters carry out photoelectric conversion for light having first and second wavelength bands, respectively, the first and second wavelength bands are different,
the first and second photoelectric converters are layered in a direction perpendicular to the light-receiving area so that the first photoelectric converter is mounted at the deepest point from the light-receiving area,
the first difference is determined on the basis of a wavelength in the first wavelength band.

19. An image sensor according to claim 1, further comprising a plurality of second pixels that comprise photoelectric converters, second optical filters, and second optical members, the second optical filter covering the photoelectric converter, a portion of light incident on the second filter having a second wavelength band and passing through the second optical filter, the second optical member covering the photoelectric converter, light incident on the second pixel passing through the second optical member, the plurality of second pixels being arranged on the light-receiving area,
the first pixel comprising a first optical filter, the first optical filter covering the photoelectric converter, a portion of light incident on the first pixel having a first wavelength band and passing through the first optical filter, the first wavelength band being different from the second wavelength band,
second differences being created for the thickness of the first optical members in two of the first pixels in a part of second pixel pairs among all second pixel pairs, the second pixel pair including two of the first pixels selected from the plurality of said first pixels.

20. An image sensor according to claim 19, wherein positions of the first pixel pairs having the first difference are predetermined according to a first arrangement rule, positions of the second pixel pairs having the second difference are predetermined according to the first arrangement rule or a second arrangement rule, which is different from the first arrangement rule.

21. An image sensor according to claim 19, wherein the first and second differences are predetermined on the basis of wavelengths in the first and second wavelength bands, respectively.

22. An image sensor according to claim 19, wherein the first and second differences are equal.

23. An image sensor comprising a plurality of first pixels that comprise photoelectric converters and are arranged on a light-receiving area,
first optical members being mounted only on the first pixels positioned in a predetermined cycle among the plurality of first pixels.

24. An image sensor comprising:
a plurality of first pixels that comprise photoelectric converters, first optical filters, and first micro lenses, the first optical filter covering the photoelectric converter, a portion of the total light incident on the first pixel having a first wavelength band and passing through the first optical filter, the first micro lens covering the photoelectric converter, light incident on the photoelectric converter passing through the first micro lens, the first pixels being arranged on a light-receiving area; and
a plurality of second pixels that comprise photoelectric converters, second optical filters, and second micro lenses, the second optical filter covering the photoelectric converter, a portion of the total light incident on the second pixel having a second wavelength band and passing through the second optical filter, the second micro lens covering the photoelectric converter, light incident on the photoelectric converter passing through the second micro lens, the second wavelength band being different from the first wavelength band, the second pixels being arranged on a light-receiving area,
first differences being created for the thickness of the first micro lenses in two of the first pixels in a part of first pixel pairs among all of the first pixel pairs, the first pixel pair including two of the first pixels selected from the plurality of said first pixels,
second differences being created for the thickness of the second micro lenses in two of the second pixels in part of second pixel pairs among all of the second pixel pairs, the second pixel pair including two of the second pixels selected from the plurality of said second pixels.

25. An image sensor according to claim 24, wherein the first pixel pairs having the first difference are arranged cyclically along a third direction on the light-receiving area, and the second pixel pairs having the second difference are arranged cyclically along a fourth direction on the light-receiving area.
